(19) United States
(12) Patent Application Publication
(10) Pub. No.: US 2019/0001299 A1
(43) Pub. Date: Jan. 3, 2019

(54) MICROCRYSTALLINE CELLULOSE PYROLYZATE ADSORBENT AND GAS SUPPLY PACKAGES COMPRISING SAME

(71) Applicant: Entegris, Inc., Billerica, MA (US)

(72) Inventors: Edward A. Sturm, New Milford, CT (US); Shaun M. Wilson, Trumbull, CT (US); Melissa A. Petruska, Newtown, CT (US)

(21) Appl. No.: 15/752,822

(22) PCT Filed: Aug. 19, 2016
(86) PCT No.: PCT/US2016/047880

§ 371 Date: Feb. 14, 2018

Related U.S. Application Data
(60) Provisional application No. 62/208,663, filed on Aug. 22, 2015.

(51) Int. Cl. B01J 20/20; C10B 53/02; B01J 20/30; B01J 20/28

(52) U.S. Cl. CPC B01J 20/20; C10B 53/02; B01J 20/3078; B01J 2220/485; B01J 20/2808; B01J 2220/4825; B01J 20/28011

(57) ABSTRACT

A cellulosic carbon pyrolyzate material is disclosed, having utility as a gas adsorbent for use in gas storage and delivery devices, gas filters, gas purifiers and other applications. The cellulosic carbon pyrolyzate material comprises microporous carbon derived from cellulose precursor material, e.g., microcrystalline cellulose. In adsorbent applications, the cellulosic carbon pyrolyzate may for example be produced in a particulate form or a monolithic form, having high density and high pore volume to maximize gas storage and delivery, with the pore size distribution of the carbon pyrolyzate adsorbent being tunable via activation conditions to optimize storage capacity and delivery for specific gases of interest. The adsorbent composition may include other non-cellulosic pyrolyzate components.

### CROSS-REFERENCE TO RELATED APPLICATION

The benefit under 35 USC 119 of U.S. Provisional Patent Application No. 62/208,663 filed Aug. 22, 2016 in the names of Edward A. Sturm, et al. for “MICROCRYSTALLINE CELLULOSE PYROLYZATE ADSORBENT AND GAS SUPPLY PACKAGES COMPRISING SAME” is hereby claimed. The disclosure of U.S. Provisional Patent Application No. 62/208,663 is hereby incorporated herein by reference in its entirety, for all purposes.

### FIELD OF THE DISCLOSURE

The present disclosure generally relates to carbon pyrolyzate materials, and more specifically relates to carbon adsorbents, such as high purity microporous carbon adsorbents, derived from renewable natural cellulose sources, to methods of making such carbon adsorbents, and to systems and processes utilizing such carbon pyrolyzate materials. Such systems and processes include fluid storage and dispensing systems and processes, e.g., for supplying process gases for manufacture of semiconductor products, flat-panel displays, solar panels, and the like, or for adsorbent-based heating and refrigeration systems and processes, or for usage in systems and processes involving gas or air filtration and/or purification, gas capture, gas separation, and the like.

### DESCRIPTION OF RELATED ART

The packaging, storage, transport, and use of many high pressure gases is complicated by potential risks of flammability, toxicity, pyrophoricity, and explosiveness in addition to the inherent physical or asphyxiation hazards.

In order to address these risks and associated hazards, various approaches have been employed to enhance the safety of specialty gas packages in which hazardous gases are stored, and from which such gases are supplied under dispensing conditions for use of the gas.

One such approach involves the provision of a gas storage and dispensing vessel holding a physical adsorbent on which the gas is reversibly adsorbed, with the gas being stored on the adsorbent at low, e.g., sub-atmospheric pressure. Such low pressure storage of gas minimizes the possibility of release or exposure during transportation and handling of the vessel, and has proven to be a very safe and reliable technology for the industry. Vessels of such type have been widely commercialized in the semiconductor manufacturing industry, e.g., for containment of hydride, halide, and organometallic gases for ion implantation, under the trademark SDS® (Entegris, Inc., Billerica, Mass., USA). The SDS3® line of such products utilizes as the physical adsorbent a high density, high capacity, monolithic microporous carbon adsorbent derived from controlled pyrolysis and activation of high purity synthetic polymers such as PVDF (polyvinylidene fluoride), PVDC (polyvinylidene chloride), PMA (polymethyl acrylate), and copolymers of these materials. These specialized carbon adsorbent materials feature porosity that accommodates reversible physical adsorption of gases of interest with low energy cost.

The art continues to seek new adsorbent materials, in the context of general efforts by contemporary industry to expand the use of renewable materials in the interests of competitiveness and sustainability.

It therefore would be a significant advance in the art to provide an adsorbent material that is economically manufactured from readily available renewable materials, and is able to provide a high capacity, high efficiency gas storage medium on which gas is sorptively retained in inventory, and from which gas can be readily desorbed under dispensing conditions in a safe and efficient manner for use in the manufacture of semiconductor products, flat-panel displays, solar panels, and the like. It would also be highly beneficial to provide a material of such type that is usefully employed in other systems and processes, e.g., adsorbent-based heating and refrigeration systems and processes, and in systems and processes involving gas or air filtration and/or purification, gas capture, gas separation, and the like.

### SUMMARY

The present disclosure generally relates to carbon pyrolyzate materials derived from cellulose starting materials, e.g., microcrystalline cellulose, having utility as carbon adsorbents for storage and dispensing of gases, e.g., process gases for manufacture of semiconductor products, flat-panel displays, solar panels, and the like, as well as utility in adsorbent-based heating and refrigeration systems and processes, and in systems and processes involving gas or air filtration and/or purification, gas capture, gas separation, and the like.

In one aspect, the disclosure relates to high purity microporous carbon adsorbents prepared from renewable natural cellulose sources, to methods of making such carbon adsorbents, and to adsorbent-based gas storage and dispensing systems and processes utilizing such carbon adsorbents.

In various aspects, the disclosure contemplates carbon pyrolyzate adsorbents of blends of materials comprising microcrystalline cellulose, such as blends comprising microcrystalline cellulose, starches, maltodextrin, and the like, and to semiconductor manufacturing processes and apparatus comprising such adsorbents, e.g., as a gas storage medium on which process gas may be stored and from which process gas may be desorbed under dispensing conditions, or alternatively in gas purification and/or filtration applications.

In another aspect, the disclosure relates to carbon adsorbent materials, and gas storage vessels and systems that incorporate such carbon adsorbent materials, as well as methods of making and using such materials, vessels, and gas storage and delivery systems.

In yet another aspect, the disclosure relates to a microporous adsorbent carbon derived from the pyrolysis of cellulose source material such as microcrystalline cellulose.

A further aspect of the disclosure relates to a gas supply package, comprising a gas supply vessel holding an adsorbent of the present disclosure.

A still further aspect of the disclosure relates to a method of making a monolithic or particulate carbon adsorbent, comprising: compressing a precursor cellulose material into a near net shape preform; heating in a controlled manner in an inert gas environment to thermally decompose the cellulose material to carbon; and, optionally, activating the carbon to increase surface area by one or more of (i) chemical activation, and (ii) physical activation.

The disclosure relates in one aspect to a cellulosic carbon pyrolyzate having reversibly adsorbed thereon a gas for manufacture of a product selected from the group consisting of semiconductor products, flat-panel displays, and solar panels.

The disclosure in a further aspect relates to a gas supply package, comprising a gas storage and dispensing vessel containing a cellulosic carbon pyrolyzate as variously described herein.

A further aspect of the disclosure relates to a method of manufacturing a product selected from the group consisting of semiconductor products, flat-panel displays, and solar panels, comprising supplying gas for said manufacturing from a gas supply package of the present disclosure.

Another aspect of the disclosure relates to a method of supplying gas for manufacturing a product selected from the group consisting of semiconductor products, flat-panel displays, and solar panels, said method comprising providing for use in a process for manufacturing the product a gas supply package of the present disclosure.

A still further aspect of the disclosure relates to a method of supplying packaged gas for use, said method comprising packaging a cellulosic carbon pyrolyzate of the disclosure in a gas supply package.

Yet another aspect of the disclosure relates to a gas purifier, comprising a housing defining an interior volume and adapted for flow of gas therethrough, and a cellulosic carbon pyrolyzate adsorbent in the interior volume of the housing, arranged for contact with the gas flowed through the housing to sorptively purify the gas.

The disclosure relates in another aspect to gas or air filtration and/or purification devices and processes containing cellulosic carbon pyrolyzate adsorbents as variously described herein.

Another aspect of the disclosure relates to a gas supply package, comprising a gas storage and dispensing vessel containing a cellulosic carbon pyrolyzate adsorbent for reversibly retaining gas thereon in an adsorbed state, and desorbing gas for discharge from the vessel under dispensing conditions of the gas supply package.

Other aspects, features and embodiments of the disclosure will be more fully apparent from the ensuing description and appended claims.

### BRIEF DESCRIPTION OF THE DRAWINGS

FIG. 1 is a schematic representation of an in-line gas purifier disposed in a process line for purification of gas flowed therethrough, utilizing a carbon pyrolyzate material according to one embodiment of the present disclosure.

FIG. 2 is a perspective schematic view of a gas purifier apparatus for adsorptive purification of a gas stream.

FIG. 3 is a perspective view of a tray of a type as shown schematically in the FIG. 2 gas purifier apparatus, showing the tray filled with granular carbon pyrolyzate adsorbent of the present disclosure, but varied from the structure of the tray shown in FIG. 2, by having a radial wall assembly that divides the volume of the tray into quadrants, each having an arc length of 90°.

FIG. 4 is a bottom perspective view of the tray of FIG. 3, showing the floor of the tray on which the carbon pyrolyzate adsorbent is loaded in the four sections.

FIG. 5 is a schematic representation of a storage and delivery system utilizing a carbon monolithic adsorbent, according to another embodiment of the present disclosure.

FIG. 6 is a perspective cross-sectional view of a gas supply package including a gas storage and dispensing vessel, showing the interior structure of such vessel, as containing a particulate carbon adsorbent, according to a further embodiment of the disclosure.

FIG. 7 is a sectional elevation view of a gas filter system according to one embodiment of the present disclosure.

FIG. 8 is a top plan view of the gas filter system of FIG. 7, showing the top inlet face of the system.

FIG. 9 is a sectional elevation view of a gas filter system according to another embodiment of the present disclosure, wherein all parts and components are numbered correspondingly to FIG. 7, but wherein, in contrast to the gas purification system of FIG. 7, the filter assembly comprises the layer of granular particles of the microcrystalline cellulose pyrolyzate adsorbent on the inlet-facing surface of the layer of fibrous filter material, so that the gas to be purified is contacted first with the adsorbent, which then flows through the fibrous filter material layer.

FIG. 10 is a top plan view of the gas filter system of FIG. 9, showing the filter assembly presented to the illustrated inlet face of the system.

FIG. 11 is a schematic partially exploded perspective view of an array of corrugated polymer film sheets.

FIG. 12 is a front elevation view of an array after fusing/bonding and pyrolysis of the array shown in FIG. 11.

FIG. 13 is a perspective view of an activated carbon honeycomb array derived from the array of FIGS. 11 and/or 12.

FIG. 14 is an exploded, partial sectional view of a microporous pyrolyzate carbon purifier apparatus according to one embodiment of the present disclosure.

FIG. 15 is a cross-sectional view, taken in a plane transverse to the longitudinal axis of the purifier apparatus of FIG. 14, showing the microcrystalline cellulose pyrolyzate adsorbent disposed in the interior volume of the housing.

FIG. 16 is a cross-sectional view of the purifier apparatus (in vertical orientation) of FIG. 14, in a plane intersecting the central longitudinal axis of the purifier apparatus, showing the microcrystalline cellulose pyrolyzate adsorbent disposed in the interior volume of the housing.

FIG. 17 is a cross-sectional view of a purifier apparatus, taken in a plane transverse to the longitudinal axis of a purifier apparatus of a type as shown in FIG. 14, showing the microcrystalline cellulose pyrolyzate adsorbent in the form of an extruded channeled monolith in the purifier housing.

FIG. 18 shows a cross-sectional view of the purifier apparatus of FIG. 17 (in vertical orientation), in a plane intersecting the central longitudinal axis of the purifier apparatus, to illustrate the channels in the extruded monolith.

FIG. 19 is a cross-sectional view of a purifier apparatus of a type as shown in FIG. 14, taken in a plane transverse to the longitudinal axis of the purifier apparatus, according to another embodiment of the disclosure.

FIG. 20 is a cross-sectional view of the purifier apparatus of FIG. 19 (in vertical orientation), in a plane intersecting the central longitudinal axis of the purifier apparatus, showing the microcrystalline cellulose pyrolyzate adsorbent in the form of particulate adsorbent in a honeycomb structure in the purifier housing.

FIG. 21 is a schematic representation of a gas delivery system according to one embodiment of the present disclosure, for a microelectronics manufacturing process facility.

FIG. 22 is a photograph of self-adherent tablets of natural carbohydrate formed by direct compression, without an added binder, and having a raw material density in excess of 1.32 g/cc.

FIG. 23 is a photograph showing a range of sizes of disks compressed from various natural carbohydrate sources.

FIG. 24 is a photograph of press-formed microcrystalline cellulose tablets having an average piece density of >1.30 g/cc.

FIG. 25 is a photograph of press-formed microcrystalline cellulose tablets as pressed, following pyrolysis to carbon, and after oxidative activation.

FIG. 26 is a photograph of several cellulosic carbon pyrolyzate articles prepared from microcrystalline cellulose, according to one embodiment of the present disclosure, as they are removed from the pyrolysis furnace, having an average density of>1.05 g/cc.

FIG. 27 is a photograph showing a variety of shapes and sizes of formed carbon pyrolyzate adsorbent pieces prepared via preforming and controlled pyrolysis.

FIG. 28 is a photograph of one embodiment of carbon pyrolyzate adsorbent articles having a space-filling shape, which can be arranged so that adjacent carbon pyrolyzate adsorbent articles are in contact with one another, so that the corresponding array of carbon pyrolyzate adsorbent articles can be employed for maximizing adsorbent density within the enclosed volume of an adsorbent vessel adapted for holding gas for which the carbon pyrolyzate adsorbent has sorptive affinity.

FIG. 29 is a series of SEM micrographs at increasing magnifications of a cleaved piece of consolidated carbon adsorbent monolith derived from compressed microcrystalline cellulose having a density of 0.77 g/cc, and a surface area of 1247 sq.m/g.

FIG. 30 is an SEM micrograph of the surface of the same consolidated carbon adsorbent monolith of FIG. 12 derived from compressed microcrystalline cellulose having a density of 0.77 g/cc, and a surface area of 1247 sq.m/g.

FIG. 31 is a higher magnification SEM image of the microporosity in the activated carbon adsorbent monolith of FIGS. 29 and 30.

FIG. 32 is a graph of burn-off level (% wt.) as a function of processing time at 900° C. in CO₂ for cellulosic carbon pyrolyzate articles prepared from microcrystalline cellulose.

FIG. 33 is a graph of surface area (both gravimetric and volumetric) of cellulosic carbon pyrolyzate articles prepared from microcrystalline cellulose, as a function of the level of burn-off.

FIG. 34 is a plot, based on an established correlation, of estimated CH₄ volumetric capacity versus level of burn-off, for cellulosic carbon pyrolyzate articles prepared from microcrystalline cellulose and activated using CO₂ at 900° C.

FIG. 35 is a graph of measured micropore volume and calculated meso+macropore volume versus burn-off level for cellulosic carbon pyrolyzate articles prepared from microcrystalline cellulose and activated using CO₂ at 900° C.

FIG. 36 is a graph of estimated ratio of millipore volume to meso+macropore volume for cellulosic carbon pyrolyzate articles prepared from microcrystalline cellulose and activated using CO₂ at 900° C., as a function of burn-off level.

FIG. 37 is a plot of nitrogen adsorption isotherms for cellulosic carbon pyrolyzate articles prepared from microcrystalline cellulose, at 77° Kelvin (volume of nitrogen adsorbed (cc nitrogen/gram), as a function of pressure).

FIG. 38 is a plot of CO₂ adsorption isotherms for cellulosic carbon pyrolyzate articles prepared from microcrystalline cellulose, at 0° C. (volume of CO₂ adsorbed (cc nitrogen/gram), as a function of pressure (torr)).

FIG. 39 is an alpha-S plot for cellulosic carbon pyrolyzate articles prepared from microcrystalline cellulose (volume of nitrogen adsorbed, in cc/g at standard temperature and pressure conditions, as a function of volume of nitrogen adsorbed, in cc/g at standard temperature and pressure conditions).

### DETAILED DESCRIPTION

The present disclosure generally relates to carbon pyrolyzate materials. In particular aspects, the disclosure relates more specifically to carbon adsorbents, such as a carbon adsorbent that is derived from cellulose starting material, e.g., microcrystalline cellulose, and which are usefully employed for reversible adsorption of gas, providing a gas storage medium on which gas can be sorptively held under gas storage conditions, and from which gas can be readily desorbed for dispensing and subsequent use. Such carbon adsorbent thus has utility for supplying process gases for manufacture of semiconductor products, flat-panel displays, solar panels, and the like, and utility in adsorbent-based heating and refrigeration systems and processes, as well as utility in systems and processes involving gas or air filtration and/or purification, gas capture, gas separation, and the like.

The disclosure, as variously set out herein in respect of features, aspects and embodiments thereof, may in particular implementations be constituted as comprising, consisting, or consisting essentially of, some or all of such features, aspects and embodiments, as well as elements and components thereof being aggregated to constitute various further implementations of the disclosure. The disclosure correspondingly contemplates such features, aspects and embodiments, or a selected one or ones thereof, in various permutations and combinations, as being within the scope of the present disclosure.

As used herein and in the appended claims, the following terms have the following meanings:

The singular forms “a”, “and”, and “the” include plural referents unless the context clearly dictates otherwise.

The term “high purity” in reference to carbon pyrolyzates of the present disclosure means that the carbon pyrolyzate is characterized by <1% total ash content, as determined by the procedure of ASTM D2866-11

The term “carbohydrates” refers to large biological molecules or macromolecules that are constituted by carbon (C), hydrogen (H), and oxygen (0) atoms. Such molecules may have a hydrogen:oxygen atom ratio of 2:1, and an empirical formula of C_{X}(H₂O)_{Y}, wherein X can be different from Y. Technically, these molecules are hydrates of carbon. Generally the term “carbohydrates” is considered synonymous with “saccharides.” Carbohydrates reside in four chemical classes: monosaccharides, disaccharides, oligosaccharides, and polysaccharides.

The term “sugars” is a generalized name for sweet, short-chain, soluble carbohydrates, constituted by carbon, hydrogen, and oxygen atoms. Examples include arabinose, fructose, galactose, glucose (dextrose), lactose, maltose, mannose, sucrose, xylose, and their derivatives.

The term “microcrystalline cellulose” refers to highly refined wood pulp cellulose prepared by separation of the insoluble three-dimensionally bonded “crystalline” portion of the wood cellulose microfibers from the weaker bonded amorphous regions and purifying. Microcrystalline cellulose has found broad use as a texturizer, extender, or bulking agent in production of processed foods and as an excipient and tableting aid for vitamins and dietary supplements.

The term “macropores” refers to pores that are greater than 50 nm in size.

The term “mesopores” refers to pores that are from 2 nm to 50 nm in size.

The term “micropores” refers to pores that are smaller than 2 nm in size.

The term “ultra-micropores” refers to pores that are smaller than 0.7 nm in size.

The term “monolith” refers to carbon pyrolyzate material that is in a bulk form, having a block, brick, cylinder, puck, rod, or other geometrically regular or irregular bulk form, as distinguished from non-monolith carbon pyrolyzate forms such as beads, pellets, extrudates, powders, granules, or particulates. Monolithic carbon pyrolyzates of the present disclosure are advantageously formed as dense solid articles by pyrolysis of “near net shape” pyrolyzable precursor preforms that have a size and conformation that substantially correspond to the monolithic carbon pyrolyzate product. The resulting bulk form microporous carbon articles can be used as single piece adsorbent, or as a stack of multiple pieces (e.g., when the monolithic carbon pyrolyzate is of disk-shaped form and a stack of such disk-shaped bodies is vertically stacked in face-to-face abutment of successive disk-shaped bodies in the stack), or other arrangements in which the bulk form carbon pyrolyzate articles contact each other over substantial portion(s) of their respective surfaces, thereby eliminating the high void volumes that are observed in adsorbent vessels that are filled by beads, pellets, extrudates, powders, granules, or particulates of adsorbent, in which there is substantial interstitial volume and gross voids that resulted in diminution of sorptive capacity of the spatial volume containing such beads, pellets, extrudates, powders, granules, or particulates. In various specific embodiments, the monolith carbon pyrolyzate may have a dimensional character in which each of its (x,y,z) dimensions is at least 1 cm, e.g., wherein each of its (x,y,z) dimensions is in a range of from 1 cm to 25 cm, or higher.

The term “piece density” refers to mass per unit volume of a single piece of solid adsorbent, expressed in units of grams per cubic centimeter.

The term “binderless” used in reference to carbon pyrolyzates that are formed from pyrolyzable precursor material means that the pyrolyzable precursor composition contains no more than 5% by weight, based on total weight of the composition, of binder material, preferably containing no more than 2% by weight binder, on the same weight basis, and most preferably being devoid of any binder material. Binderless carbon pyrolyzates thus can be formed from precursor material that is sufficiently cohesive so that it can be formed in a near net shape form by press-molding or other shaping operations, and retain that near net shape form during and subsequent to the pyrolysis of the precursor material. In this respect, residual adsorbed species, e.g., water or moisture, resulting from standard processing operations such as milling and packaging are considered to be part of the raw source material and not to be additive or binder components of the raw source material.

The term “pyrolysis” refers to thermal decomposition of precursor material under inert gas cover at conditions in which the precursor material is converted substantially to carbon.

The term “near net shape” in reference to the pyrolyzable precursor article that is pyrolyzed to form the carbon pyrolyzate, means that the precursor article has a conformation that is consistent shape-wise with the product carbon pyrolyzate resulting from the pyrolysis. Such character of the pyrolyzable precursor article in relation to the pyrolyzed product article is highly advantageous, since it eliminates the need for extensive cutting, grinding, etc. to effect material removal in the processing of the carbon pyrolyzate, inasmuch as a reasonably consistent form factor is maintained in progressing from the precursor article to the carbon pyrolyzate adsorbent product.

The term “cellulosic carbon pyrolyzate” refers to a carbon pyrolyzate formed by pyrolysis of precursor material comprising cellulose.

The precursor material for the cellulosic carbon pyrolyzate may be constituted by only cellulose precursor material, or the precursor material for the cellulosic carbon pyrolyzate may comprise the cellulose precursor material together with (i) additives to facilitate or enhance the pyrolysis process or the carbon pyrolyzate product of the process (e.g., pore formers, viscosity control agents, surfactants, etc.), and/or (ii) other pyrolyzable precursor material(s). Such other pyrolyzable precursor material(s) may include synthetic polymeric materials (e.g., polyvinylidene chloride polymers and copolymers, polyvinylidene fluoride polymers and copolymers, etc.), petroleum-based materials, petroleum-derived materials, carbohydrates other than cellulose (e.g., sugars, saccharides, starches, maltodextrin, etc.), and combinations, blends, and mixtures of the foregoing. The cellulose precursor material may comprise different cellulose constituents, such as for example a mixture of wood pulp and apricot pits, or a mixture of rice husks and cotton linters.

A preferred form of the cellulose starting material for the cellulosic carbon pyrolyzate is microcrystalline cellulose.

In various embodiments, the cellulose precursor material may be employed as a component of a pyrolyzable precursor material mixture comprising the cellulose precursor material and non-cellulose precursor material, and in such precursor material mixture, the cellulose precursor material may be present at a concentration of from 5% to 98% by weight, based on total weight of the cellulose and non-cellulose precursor materials in the mixture. In other embodiments, the cellulose precursor material may be present at a concentration of at least 50% by weight, on the same total weight basis, or at concentration of at least one of 55%, 60%, 65%, 70%, 75%, 80%, 85%, 90%, and 95% by weight, up to 98% by weight on the same total weight basis. For example, the cellulose precursor material may be present at concentration of from 55% to 98% by weight, based on total weight of the cellulose and non-cellulose precursor materials in the mixture, or from 60% to 80% by weight, or from 65% to 95% by weight, or from 70% to 90% by weight percent, or in other ranges having endpoints selected from the individual percentages above, wherein all such weight percentages are on the same total weight basis.

In various aspects, the disclosure relates to a cellulosic carbon pyrolyzate.

The cellulosic carbon pyrolyzate in various embodiments may be characterized by: <1% total ash content, as determined by the procedure of ASTM D2866-11; piece density in a range of from 0.50 g/cc to 1.40 g/cc; N₂ BET surface area greater than 750 m2/gm; and methane adsorption capacity, at 21° C. and 35 bar pressure, of greater than 100 V/V.

Another aspect of the disclosure relates to a gas supply package containing a cellulosic carbon pyrolyzate as a gas storage medium on which gas may be adsorbed for storage, and from which gas may be desorbed under dispensing conditions and dispensed from the gas supply package to a location of use, e.g., in a manufacturing process system for production of semiconductor products, flat-panel displays, solar panels, etc.

The carbon pyrolyzate adsorbent for such use may be in an activated form, e.g., wherein the activated form has been activated by chemical and/or physical activation. In one specific embodiment, the activated form has been chemically activated by reaction with an acid, e.g., an acid selected from the group consisting of hydrochloric acid, sulfuric acid, phosphoric acid, boric acid, and carbonic acid. In other embodiments, the activated form has been chemically activated by reaction with a hydroxide of sodium, lithium, potassium, calcium, or ammonium. In still other embodiments, the activated form has been physically activated by burn-off in exposure to CO₂, air, or steam in mixture with an inert gas, e.g., nitrogen or argon, or as a pure gas stream at temperature in a range of from 600° C. to 1200° C.

The cellulosic carbon pyrolyzate adsorbent of the disclosure in specific embodiments may be characterized by any one or more of the following characteristics: having less than 0.5% total ash content, as determined by the procedure of ASTM D2866-11; having a piece density of from 0.55 g/cc to 1.35 g/cc; having a piece density of from 0.60 g/cc to 1.30 g/cc; having a bulk density of from 0.5 g/cc to 1.3 g/cc; the adsorbent being binderless; having N₂ BET surface area in a range of from 750 to 3000 m2/gram; having at least 40% of its pore volume in micropores having size in a range of from 0.3 nm to 2.0 nm; having at least 70% of its pore volume in micropores having size in a range of from 0.3 nm to 2.0 nm; having from 40% to 90%, or higher, of its pore volume in micropores having size in a range of from 0.3 nm to 2.0 nm; having methane adsorption capacity, at 21° C. and 35 bar pressure, of greater than 110 V/V; having methane adsorption capacity, at 21° C. and 35 bar pressure, of greater than 125 V/V; having methane adsorption capacity, at 21° C. and 35 bar pressure, in a range of from 140 V/V to 220 V/V; and having methane adsorption working/delta capacity between 35 bar and 1 bar, of at least 75 V/V, e.g., in a range of from 75 to 125 V/V.

The cellulosic carbon pyrolyzate adsorbent of the disclosure in other embodiments may have adsorbed thereon gas selected from the group consisting of hydrides, halides, organometallics, hydrogen, CO₂, CO, C₂-C₄ hydrocarbons (e.g., ethane, ethylene, propane, propylene, butane, butylene), and mixtures of two or more of the foregoing. In embodiments wherein the semiconductor manufacturing gas comprises a gas mixture of two or more of the foregoing, or a gas mixture including one or more of the foregoing in combination with one or more of co-flow gases, carrier gases, and diluents, the concentration of each component gas of the gas mixture may be in a range of from 2 to 98% by volume, wherein the volume percentages of all component gases of the gas mixture total to 100 volume percent.

In specific embodiments, the adsorbed gas comprises gas selected from the group consisting of arsine, phosphine, germane, diborane, silane, disilane, trimethyl silane, tetramethyl silane, C₂-C₄ hydrocarbons (e.g., ethane, ethylene, propane, propylene, butane, butylene), acetylene, hydrogen, stibine, boron trichloride, boron trifluoride, diboron tetrafluoride, nitrogen trifluoride, germanium tetrafluoride, silicon tetrafluoride, arsenic trifluoride, arsenic pentafluoride, phosphine trifluoride, phosphorous pentafluoride, fluorine, chlorine, hydrogen fluoride, hydrogen sulfide, hydrogen selenide, hydrogen telluride, halogenated methanes, halogenated ethanes, allane, stannane, trisilane, ammonia, carbon monoxide, carbon dioxide, carbonyl fluoride, nitrous oxide, isotopically enriched variants of the foregoing, and combinations of two or more of the foregoing.

In specific embodiments wherein the adsorbed gas comprises an isotopically enriched variant of one or more of the foregoing gases, the gas comprising an isotopically enriched variant may be isotopically enriched above natural abundance level of at least one isotope of an element thereof, wherein the isotopically enriched level above the natural abundance level is in a range of from 5% to 100% of the difference between natural abundance level and 100% isotopic concentration in the gas of the isotopically enriched element. In specific embodiments, the isotopic enrichment level based on such difference is at least one of 5%, 10%, 15%, 20%, 25%, 30%, 35%, 40%, 45%, 50%, 55%, 60%, 65%, 70%, 75%, 80%, 85%, 90%, 95%, 99%, 99.5%, 99.9%, and 100% of such difference. For example, the gas may comprise an isotopically-enriched boron-containing gas, or an isotopically-enriched silicon-containing gas, or an isotopically-enriched germanium-containing gas.

The disclosure in a further aspect relates to a gas supply package, comprising a gas supply vessel holding a cellulosic carbon pyrolyzate adsorbent of the present disclosure as variously described herein. The vessel in specific embodiments is characterized by an adsorbent fill of at least 0.1 grams of the adsorbent per cc of interior volume of the vessel, preferably an adsorbent fill of at least 0.6 grams of the adsorbent per cc of interior volume of the vessel, more preferably an adsorbent fill of at least 0.65 grams of the adsorbent per cc of interior volume of the vessel, and most preferably an adsorbent fill of at least 0.75 grams of the adsorbent per cc of interior volume of the vessel, e.g., in a range of from 0.5 to 0.95, or higher, grams of the adsorbent per cc of interior volume of the vessel.

In another specific embodiment, the disclosure relates to a gas supply package as variously described herein, having semiconductor manufacturing gas adsorbed on the adsorbent. The semiconductor manufacturing gas may comprise any gas species having utility in semiconductor manufacturing, and may include dopant gases for ion implantation, precursors for vapor deposition processes such as chemical vapor deposition or atomic layer deposition, etchants, cleaning reagents, etc., as well as gas mixtures including the foregoing gases in combination with co-flow gases, carrier gases, diluents, etc.

The disclosure in another aspect relates to a method of making a cellulosic carbon pyrolyzate, comprising: compressing a cellulose precursor material into a near net shape preform; heating in a controlled manner in an inert gas environment to thermally decompose the carbohydrate to carbon; and, optionally, activating the carbon to increase surface area by one or more of (i) chemical activation, and (ii) physical activation.

To achieve a high level of practical utility for adsorbed gas storage and delivery, the cellulosic carbon pyrolyzate adsorbent of the present disclosure is advantageously manufactured as a high density, monolithic or particulate, shaped space-filling form material that provides both high gravimetric (storage/gram) and volumetric (storage/liter) gas storage density. The cellulosic carbon pyrolyzate adsorbent is microporous, and advantageously includes porosity having an effective pore diameter matched to the targeted adsorbate gas for the application. The porosity preferably includes less than 60% of the pore volume in mesopores (pores having a diameter of greater than 2 nm but less than 50 nm) and/or in macropores (pores of greater than 50 nm diameter). More preferably, the percentage of such pores (mesopores+macropores) is less than 45%, and most preferably the percentage of such pores (mesopores+macropores) is less than 30%.

The cellulosic carbon pyrolyzate adsorbent of the disclosure possesses high methane adsorption capacity, e.g., at least 100 V/V at 35 bar (508 psig) and 21° C., preferably greater than 110 V/V at 35 bar (508 psig) and 21° C., more preferably greater than 125 V/V at 35 bar (508 psig) and 21° C., and most preferably greater than 140 V/V at 35 bar (508 psig) and 21° C., e.g., in a range of from 100 to 250 V/V at 35 bar (508 psig) and 21° C., and more preferably in a range of from 125 to 220 V/V at 35 bar (508 psig) and 21° C.

The cellulosic carbon pyrolyzate adsorbent also exhibits rapid adsorption/desorption rates, with a low heat of adsorption and a high heat capacity permitting the adsorbent to manage heat effects and minimize temperature changes during adsorption and desorption. The adsorbent advantageously has a hydrophobic character. The adsorbent in various embodiments is prepared in a monolithic form and can be molded into a variety of shapes from the precursor materials described herein. In other embodiments, the adsorbent is prepared in a particulate form. In various embodiments, the cellulosic carbon pyrolyzate adsorbent exhibits density of 1.1 g/cc or higher and is hydrophobic with a methane capacity, at 35 bar pressure and temperature of 21° C., of at least 140 V/V. The cellulosic carbon pyrolyzate adsorbents of such type advantageously possesses a moderate heat capacity (e.g., on the order of 1 J/g-K) and a high thermal conductivity (e.g., ˜0.8 W/m-K) to provide for heat dissipation.

The cellulosic carbon pyrolyzate adsorbent of the present disclosure thus can be provided as a high surface area, microporous carbon adsorbent in a high density monolithic form and can be shaped as desired for end use of the product carbon pyrolyzate adsorbent. To keep processing cost low and the final product pure, the cellulose precursor material is preferably free or substantially free of inorganic contaminants such as transition metals, alkali or alkaline earth metals, halides, salts, etc. The cellulosic carbon pyrolyzate provides a low-cost, highly efficiency adsorbent for the storage of gas, with characteristics in specific embodiments including a surface area that is greater than 750 m²/g, a piece density that is greater than 0.75 g/cc, and a bulk density that is greater than 0.5 g/cc.

The cellulose precursor material can be easily formed or pressed into a desired shape or shapes, e.g., particulate or monolithic shapes, before undergoing subsequent carbonization and activation. Byproducts of the non-oxidative pyrolysis of carbohydrates are primarily water vapor with low levels of carbon dioxide and/or carbon monoxide. These are easily managed process effluents.

The precursor material for the cellulosic carbon pyrolyzate can be pyrolyzed at any suitable temperature, e.g., temperature of at least 400° C. and up to 1200° C., or higher, in an inert atmosphere. Activation can be carried out in any suitable manner, and may be carried out by chemical and/or physical activation techniques, e.g., (1) chemical activation by reaction of the pyrolyzed carbon with KOH, LiOH, NaOH, NH₄OH, NaHCO₃, (NH₄)₂SO₄, H₂SO₄, HCl, or H₃PO₄ at room temperature, followed by heating, and then removal of any residual activation chemistry by appropriate acid or base neutralization wash/water rinse filtering and drying; or (2) physical activation by high-temperature exposure of the carbon to steam, CO₂, air, or other oxidizing gas, or by any combination of these various techniques.

In various adsorbent embodiments, the cellulosic carbon pyrolyzate adsorbent comprises a binderless, high density carbon monolith that is in a shape-filling form with respect to the vessel or other containment structure in which the adsorbent is to be deployed as a gas storage and dispensing medium. As used in such context, the term “high density” means that the carbon pyrolyzate has a piece density of at least 0.50 g/cc, preferably at least 0.70 g/cc, and most preferably greater than 0.75 g/cc, e.g., in a range of from 0.50 g/cc to 1.70 g/cc. Alternatively, the cellulosic carbon pyrolyzate adsorbent may be in a particulate form, e.g., as powders, granules, pellets, or other particulate form.

The cellulosic carbon pyrolyzate adsorbent may be prepared to provide a N₂ BET surface area of at least 750 m²/g, preferably at least 900m²/g; and most preferably greater than 1000 m²/g, e.g., in a range of from 750 m²/g to 3000 m²/g.

In various embodiments, the microporous cellulosic carbon pyrolyzate material of the disclosure may have at least 50% of its pore volume constituted by pores of size between 0.3 nm and 2.0 nm, preferably with at least 70%, and more preferably greater than 75%, e.g., up to 95% or higher, of its pore volume constituted by pores of size between 0.3 nm and 2.0 nm in size.

Other embodiments of the disclosure relate to monolithic form cellulosic carbon pyrolyzate adsorbent, wherein the adsorbent has a methane adsorption capacity at 21° C. and 35 bar of at least 100 V/V, preferably at least 110 V/V, and more preferably at least 125 V/V, e.g., in a range of from 140 to 220 V/V.

In other aspects, the present disclosure relates to a gas supply vessel containing the cellulosic carbon pyrolyzate adsorbent, wherein the carbon adsorbent fill density within the vessel is at least 0.1 g of carbon adsorbent/cc of vessel volume occupied by the adsorbent, preferably at least 0.6 g/cc, more preferably 0.65 g/cc, and most preferably at least 0.75 g/cc, e.g., in a range of from 0.5 g/cc to 1.0 g/cc or higher.

Further aspects of this disclosure relate to a gas supply vessel containing a cellulosic carbon pyrolyzate adsorbent having adsorbed thereon gas selected from the group consisting of (i) hydrides, (ii) halides, (iii) organometallics, (iv) hydrogen, (v) carbon dioxide, (vi) carbon monoxide, (vii) methane, (viii) natural gas, (ix) ethane, (x) ethylene, (xi) propane, (xii) propylene, (xiii) butane, (xiv) butylene, and combinations of two or more of these gases.

Still further aspects of this disclosure relate to a gas supply vessel containing a cellulosic carbon pyrolyzate adsorbent having adsorbed thereon gas selected from the group consisting of arsine, phosphine, germane, diborane, silane, disilane, trimethyl silane, tetramethyl silane, C₂-C₄ hydrocarbons (e.g., ethane, ethylene, propane, propylene, butane, butylene), acetylene, hydrogen, stibine, boron trichloride, boron trifluoride, diboron tetrafluoride, nitrogen trifluoride, germanium tetrafluoride, silicon tetrafluoride, arsenic trifluoride, arsenic pentafluoride, phosphine trifluoride, phosphorous pentafluoride, fluorine, chlorine, hydrogen fluoride, hydrogen sulfide, hydrogen selenide, hydrogen telluride, halogenated methanes, halogenated ethanes, allane, stannane, trisilane, ammonia, carbon monoxide, carbon dioxide, carbonyl fluoride, nitrous oxide, isotopically enriched variants of the foregoing, and combinations of two or more of the foregoing.

In other aspects, the disclosure relates to gas adsorption, storage, transportation, and/or delivery systems incorporating the vessel(s) of the above-described types, containing cellulosic carbon pyrolyzate adsorbent of the present disclosure.

In various specific embodiments, the cellulosic carbon pyrolyzate of the present disclosure may be characterized by at least one of: having a monolithic form; <1% total ash content, as determined by the procedure of ASTM D2866-11; monolithic form piece density of from 0.50 g/cc to 1.70 g/cc; N₂ BET surface area of greater than 750m²/g; methane adsorption capacity at 21° C. and 35 bar pressure of greater than 100 V/V, e.g., greater than 110 V/V, greater than 125 V/V, or in a range of from 100 to 220 V/V; at least 40% of its porosity, e.g., greater than 50%, 60%, 70%, or 80% of its porosity, up to 90% or higher, constituted by micropores, having pore size between 0.3 nm and 2.0 nm; a thermal conductivity of >0.6 W/mK; and a methane adsorption working/delta capacity of 75 V/V or greater between 35 bar at 21° C. and 1 bar at 21° C. (the methane adsorption working/delta capacity is the volume of sorbate gas that can be adsorbed on the carbon adsorbent at the higher pressure (35 bar) and subsequently released from the carbon adsorbent by desorption at the lower pressure condition (1 bar) when both are measured at a temperature of 21° C.).

The disclosure in another aspect relates to cellulose precursor material compressed into near net shape preforms under compressive force of 4,000 psi or greater, preferably between 5,000 psi and 50,000 psi, prior to thermal decomposition.

The disclosure in yet another aspect relates to thermal conversion of the consolidated near net shape cellulose preform to carbon by treatment to a temperature ranging from 600° C. to 1200° C. to yield a cellulosic carbon pyrolyzate.

The disclosure in a further aspect relates to activation of the formed cellulosic carbon pyrolyzate by chemical or physical means to enhance surface area and micropore volume thereof.

The cellulosic carbon pyrolyzate materials of the present disclosure can be made at relatively high yields, low cost, high purity, and minimized environmental hazards. Preparing compressed preforms of the cellulose precursor material enables the production of high density monolithic forms of the carbon pyrolyzate. Pyrolysis of such materials results in easily managed byproducts. Physical activation at elevated temperature with steam, CO₂, or air in combination with inert purge gas such as nitrogen or argon can be utilized to achieve very precise control over properties such as surface area, bulk density, and pore-size distribution, without introducing new impurities or contaminants. Self-adherent (cohesive) cellulose precursor material enables processing without the use of binders that may alter the desired properties of the carbon pyrolyzate, while still achieving carbon pyrolyzate articles of high density, superior strength and durability, high heat capacity, and good thermal conductivity. As a result, it is possible to produce a solid adsorbent carbon pyrolyzate with high gas adsorption capacity, low heating during adsorption to enable rapid gas filling, minimized chemical reactivity with the adsorbed gas for shelf storage and transport stability and maximized gas delivery, and low cooling upon gas delivery to enable sustainable high use rates and a sustainable supply chain.

It will be recognized that the cellulosic carbon pyrolyzate adsorbent of the present disclosure may incorporate any of the various characteristics and features described hereinabove, and any combinations of two or more of such characteristics and features.

Cellulosic carbon pyrolyzate in accordance with the present disclosure may be provided in any suitable size, shape and form. For example, the cellulosic carbon pyrolyzate in various embodiments can be particulate in character, and in specific embodiments particles may be in a size (diameter or major dimension) range of from 0.3 to 4 mm, with a piece density that is greater than 0.8 g/cc, or with size and density of any other suitable values. In other embodiments, the cellulosic carbon pyrolyzate may be in a monolithic form. Carbon pyrolyzate monoliths useful in the broad practice of the present disclosure may in specific embodiments include gross brick, block, tablet, and ingot forms, as bulk forms. In various embodiments, carbon pyrolyzate monoliths may have three-dimensional (x, y, z) character wherein each of such dimensions is greater than 1.5, and preferably greater than 2 centimeters.

In various carbon pyrolyzate adsorbent embodiments, the carbon pyrolyzate is provided as a carbon pyrolyzate adsorbent monolith, in the form of disk-shaped articles of a same diameter, enabling such articles to be stacked in a vertical stack in a gas storage and dispensing vessel for reversible storage of gas thereon.

Thus, the present disclosure contemplates in one aspect a cellulosic carbon pyrolyzate having reversibly adsorbed thereon a gas for manufacture of a product selected from the group consisting of semiconductor products, flat-panel displays, and solar panels.

Such cellulosic carbon pyrolyzate in various embodiments comprises a pyrolyzate of one or more of wood pulp, sawdust, newsprint, coconut shells, olives stones, peach stones, apricot pits, viscose, viscose-rayon, cotton, cotton linters, argan nutshell, macadamia nutshell, cellulose acetate, bacterial cellulose, lignin, blackthorn stones, walnut shells, date stones, rice husks, coffee parchment, coffee dregs, bagasse, sorghum millets straws, bamboo woods, mango pits, almond shells, corncobs, cherry stones, and grape seeds. In a specific aspect, the cellulosic carbon pyrolyzate comprises a pyrolyzate of microcrystalline cellulose.

In the above-discussed cellulosic carbon pyrolyzate, the gas may comprise one or more selected from the group consisting of hydrides, halides, organometallics, hydrogen, CO₂, CO, C₂-C₄ hydrocarbons, and mixtures of two or more of the foregoing.

In various embodiments, the gas comprises one or more selected from the group consisting of ethane, ethylene, propane, propylene, butane, and butylene. In other embodiments, the gas comprises one or more selected from the group consisting of arsine, phosphine, germane, diborane, silane, disilane, trimethyl silane, tetramethyl silane, C₂-C₄ hydrocarbons, acetylene, hydrogen, stibine, boron trichloride, boron trifluoride, diboron tetrafluoride, nitrogen trifluoride, germanium tetrafluoride, silicon tetrafluoride, arsenic trifluoride, arsenic pentafluoride, phosphine trifluoride, phosphorous pentafluoride, fluorine, chlorine, hydrogen fluoride, hydrogen sulfide, hydrogen selenide, hydrogen telluride, halogenated methanes, halogenated ethanes, allane, stannane, trisilane, ammonia, carbon monoxide, carbon dioxide, carbonyl fluoride, nitrous oxide, isotopically enriched variants of the foregoing, and combinations of two or more of the foregoing.

In specific embodiments the gas may comprise hydride gas, halide gas, or gaseous organometallic. For example, the gas may in specific implementations comprise gas selected from the group consisting of (i) hydrides, (ii) halides, (iii) organometallics, (iv) hydrogen, (v) carbon dioxide, (vi) carbon monoxide, (vii) methane, (viii) natural gas, (ix) ethane, (x) ethylene, (xi) propane, (xii) propylene, (xiii) butane, (xiv) butylene, and combinations of two or more of these gases.

The gas may comprise a semiconductor manufacturing gas, e.g., gas selected from the group consisting of dopant gases for ion implantation, precursors for vapor deposition processes, etchants, cleaning reagents, gas mixtures of two or more of the foregoing, and gas mixtures including one or more of the foregoing gases in combination with one or more of co-flow gases, carrier gases, and diluents.

In various embodiments, wherein the semiconductor manufacturing gas comprises a gas mixture of two or more of the foregoing, or a gas mixture including one or more of the foregoing in combination with one or more of co-flow gases, carrier gases, and diluents, concentration of each component gas of the gas mixture may be in a concentration in a range of from 2 to 98% by volume, wherein the volume percentages of all component gases of the gas mixture total to 100 volume percent. For example, the gas concentration may be at least one of 5%, 10%, 15%, 20%, 25%, 30%, 35%, 40%, 45%, 50%, 55%, 60%, 65%, 70%, 75%, 80%, 85%, 90%, 95%, 97%, and 98%, and may be in a range defined by any of the foregoing numbers at the upper and lower numerical limits thereof, wherein the upper limit is greater than the lower limit, such as for example a range of from 10% to 65%, a range of 40% to 75%, or other appropriate range for the specific application involved.

The foregoing cellulosic carbon pyrolyzate in specific embodiments may be characterized by any one or more of the following characteristics: having less than 0.5% total ash content, as determined by the procedure of ASTM D2866-11; having a piece density of from 0.55 g/cc to 1.35 g/cc; having a piece density of from 0.60 g/cc to 1.30 g/cc; having a bulk density of from 0.5 g/cc to 1.3 g/cc; the adsorbent being binderless; having N₂ BET surface area in a range of from 750 to 3000 m2/gram; having at least 40% of its pore volume in micropores having size in a range of from 0.3 nm to 2.0 nm; having at least 70% of its pore volume in micropores having size in a range of from 0.3 nm to 2.0 nm; having from 40% to 90%, or higher, of its pore volume in micropores having size in a range of from 0.3 nm to 2.0 nm; having methane adsorption capacity, at 21° C. and 35 bar pressure, of greater than 110 V/V; having methane adsorption capacity, at 21° C. and 35 bar pressure, of greater than 125 V/V; having methane adsorption capacity, at 21° C. and 35 bar pressure, in a range of from 140 V/V to 220 V/V; and having methane adsorption working/delta capacity between 35 bar and 1 bar, of at least 75 V/V, e.g., in a range of from 75 to 125 V/V.

In other embodiments, the cellulosic carbon pyrolyzate may be characterized by <1% total ash content, as determined by the procedure of ASTM D2866-11; piece density in a range of from 0.50 g/cc to 1.40 g/cc; N₂ BET surface area greater than 750 m2/gm; and methane adsorption capacity, at 21° C. and 35 bar pressure, of greater than 100 V/V. Other embodiments of the cellulosic carbon pyrolyzate may be characterized by a methane adsorption capacity at 35 bar (508 psig) and 21° C. of at least 100 V/V.

The cellulosic carbon pyrolyzate may be in a monolithic form, or in a particulate form, or a combination of these or different forms. The cellulosic carbon pyrolyzate may in specific embodiments comprise porosity including less than 60% of pore volume in mesopores and/or in micropores. The cellulosic carbon pyrolyzate in still other embodiments may be characterized by any of the following: density of at least 1.1 g/cc and methane capacity, at 35 bar pressure and temperature of 21° C., of at least 140 V/V; surface area that is greater than 750 m²/g, a piece density that is greater than 0.8 g/cc, and a bulk density that is greater than 0.5 g/cc.; N₂ BET surface area of at least 750 m²/g; porosity including at least 50% of pore volume constituted by pores of size between 0.3 nm and 2.0 nm.

The cellulosic carbon pyrolyzate of the disclosure in various embodiments may comprise a pyrolyzate of cellulose precursor material and one or more non-cellulose precursor material. For example, the one or more non-cellulose precursor material may be selected from the group consisting of synthetic polymeric materials, petroleum-based materials, petroleum-derived materials, carbohydrates other than cellulose, and combinations, blends, and mixtures of the foregoing. As a further specific example, the one or more non-cellulose precursor material may be selected from the group consisting of polyvinylidene chloride polymers and copolymers, and polyvinylidene fluoride polymers and copolymers. As still a further specific example, the one or more non-cellulose precursor material may be selected from the group consisting of starches and maltodextrins. As yet another example, the cellulosic carbon pyrolyzate may comprise a pyrolyzate of cellulose precursor material comprising two or more different cellulose materials. When the cellulosic carbon pyrolyzate comprises a pyrolyzate of cellulose precursor material and non-cellulose precursor material, the concentration of cellulose precursor material in specific embodiments may be at least 50% by weight, based on total weight of the cellulose precursor material and non-cellulose precursor material.

The cellulosic carbon pyrolyzate of the disclosure may be activated, and may comprise a pyrolyzate activated by chemical and/or physical activation, e.g., wherein the pyrolyzate has been activated by burn-off in exposure to CO₂, air, or steam in mixture with an inert gas or as a pure gas stream at temperature in a range of from 600° C. to 1200° C.

For example, the burn-off gas may comprise CO₂ in mixture with an inert gas, and in various embodiments, CO₂ may be present in the burn-off gas at a concentration in a range of from 30% to 98% by volume, based on total volume of the burn-off gas. In other embodiments, the concentration of CO₂ in the burn-off gas may be at least one of 35%, 40%, 45%, 50%, 55%, 60%, 65%, 70%, 75%, 80%, 85%, 90%, 95%, 97%, and 98%, and may be in a range defined by any of the foregoing numbers at the upper and lower numerical limits thereof, wherein the upper limit is greater than the lower limit, such as for example a range of from 40% to 65%, a range of 50% to 85%, or other appropriate range for the specific application involved.

As another example, the burn-off gas may comprise air in mixture with an inert gas, and in various embodiments, air may be present in the burn-off gas at a concentration in a range of from 30% to 98% by volume, based on total volume of the burn-off gas. In other embodiments, the concentration of air in the burn-off gas may be at least one of 35%, 40%, 45%, 50%, 55%, 60%, 65%, 70%, 75%, 80%, 85%, 90%, 95%, 97%, and 98%, and may be in a range defined by any of the foregoing numbers at the upper and lower numerical limits thereof, wherein the upper limit is greater than the lower limit, such as for example a range of from 40% to 65%, a range of 50% to 85%, or other appropriate range for the specific application involved.

As still another example, the burn-off gas may comprise steam in mixture with an inert gas, and in various embodiments, steam may be present in the burn-off gas at a concentration in a range of from 30% to 98% by volume, based on total volume of the burn-off gas. In other embodiments, the concentration of steam in the burn-off gas may be at least one of 35%, 40%, 45%, 50%, 55%, 60%, 65%, 70%, 75%, 80%, 85%, 90%, 95%, 97%, and 98%, and may be in a range defined by any of the foregoing numbers at the upper and lower numerical limits thereof, wherein the upper limit is greater than the lower limit, such as for example a range of from 40% to 65%, a range of 50% to 85%, or other appropriate range for the specific application involved.

The disclosure in a further aspect relates to a gas supply package, comprising a gas storage and dispensing vessel containing a cellulosic carbon pyrolyzate as variously described herein.

A further aspect of the disclosure relates to a method of manufacturing a product selected from the group consisting of semiconductor products, flat-panel displays, and solar panels, comprising supplying gas for said manufacturing from a gas supply package of the present disclosure.

Another aspect of the disclosure relates to a method of supplying gas for manufacturing a product selected from the group consisting of semiconductor products, flat-panel displays, and solar panels, such method comprising providing for use in a process for manufacturing the product a gas supply package of the present disclosure.

A still further aspect of the disclosure relates to a method of supplying packaged gas for use, such method comprising packaging a cellulosic carbon pyrolyzate of the disclosure in a gas supply package.

The disclosure in another aspect contemplates a gas purifier, comprising a housing defining an interior volume and adapted for flow of gas therethrough, and a cellulosic carbon pyrolyzate adsorbent as variously described herein in the interior volume of the housing, arranged for contact with the gas flowed through the housing to sorptively purify the gas.

The disclosure relates in another aspect to a gas purification system and method employing one or more gas purifier devices, such that gas can be flowed simultaneously or alternatingly through the interior volume of said purifiers where it can be adsorptively contacted by one or more cellulosic carbon pyrolyzate adsorbents as variously described herein, and whereby such contact yields a gas stream of higher purity than the original gas source.

In a further aspect the disclosure contemplates an air filter and/or air purifier assembly, system and method comprising a housing holding a pleated filtration media which is enhanced to comprise cellulosic carbon pyrolyzate adsorbent as variously described herein in particulate form for rapid adsorption of impurities from an air stream directed through the filter/purifier.

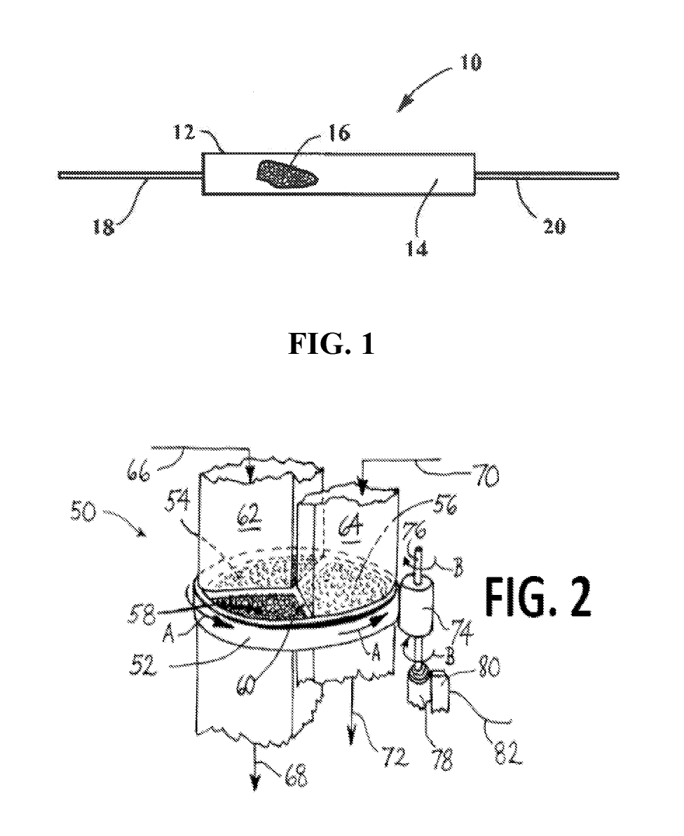

Referring now to the drawings, FIG. 1 is a schematic representation of an in-line gas purifier 10 disposed in a process line for purification of gas flowed therethrough, utilizing a cellulosic carbon pyrolyzate material according to one embodiment of the present disclosure.

As illustrated, the purifier 10 comprises a purifier vessel 12 of cylindrical elongate shape, coupled in gas flow relationship with a gas inlet line 18 at a first end of the vessel, and coupled in gas flow relationship with a gas outlet line 20 at a second end of the vessel opposite the first end thereof The purifier vessel 12 includes a circumscribing cylindrical wall 14 defining an enclosed interior volume therewithin, bounded by end walls at the first and second ends of the vessel. In the interior volume is disposed a particulate cellulosic carbon pyrolyzate adsorbent in accordance with the present disclosure. Such adsorbent has selective adsorptive affinity for one or more components of a gas mixture flowed from gas inlet line 18 through the interior volume of the vessel 12 to the gas outlet line 20, so that such components are selectively removed from the gas mixture flowed through the purifier to produce a purified gas depleted in such components.

The gas inlet line 18 and gas outlet line 20 may be part of flow circuitry in a semiconductor manufacturing facility, in which the gas mixture flowed to the purifier from gas inlet line 18 is desired to be purified of the selectively removable components. The purifier thus may purify gas to be utilized in a specific gas-utilizing operation in the semiconductor manufacturing facility, or the purifier may be used to remove residual toxic or otherwise hazardous components from the gas prior to its release as effluent from the facility. The purifier may be deployed in clean room and lithography track applications. The cellulosic carbon pyrolyzate adsorbent material may thus be utilized in the purifier in a particulate form, as a powder, beads, pellets, extrudate, granules, or the like. Alternatively, if the pressure drop in the purifier is sufficiently low, the cellulosic carbon pyrolyzate adsorbent material may be provided in a monolithic form or as a monolith or block containing narrow gas flow channels, e.g. a honeycomb. As a still further arrangement in various embodiments, the cellulosic carbon pyrolyzate adsorbent material may be provided on a support material or batting, to effect contact of the gas with the adsorbent material so that undesired components are adsorptively removed therefrom by such contacting.

It is further represented here that two or more gas purifiers as depicted in FIG. 1 could be used in parallel or in series containing similar or varied cellulose carbon pyrolyzate adsorbents for simultaneous or alternating treatment of the process gas for optimal purification.

FIG. 2 is a perspective schematic view of a gas purifier apparatus 50 for adsorptive purification of a gas stream.

The gas purifier apparatus 50 includes a rotatable disk-shaped tray 52 that is partitioned by the radial wall assembly 60 into three discrete tray sections 54, 56, and 58, as illustrated, each of such sections having a circumferential extent of 120°, so that each of the sections is of equal volume. In each of the sections there is disposed an adsorbent of granular form. The tray 52 is adapted for rotation in the direction indicated by arrows A by a drive roller 74 mounted on shaft 76 and arranged for counter-directional rotational movement in the direction indicated by arrows B, in relation to the rotational direction A of the disc 52 when driven by such drive roller.

The drive roller as indicated is mounted on shaft 76 which in turn is coupled with drive motor 78 that in turn is coupled with a variable drive actuator for driving the drive motor 78 at a selected speed. The variable drive actuator and motor are supplied with electrical power by means of electrical power line 82.

The tray 52 is arranged with a shroud 64 above and below the rotating tray, with the respective upper and lower shroud sections being in registry with one another, defining an interior volume to which gas to be purified is introduced in gas feed line 70. By such arrangement, the introduced gas flows downwardly in the shroud, from the upper shroud section to the lower shroud section, so that it passes through and is contacted with the adsorbent in the section 56 of the tray. As a result of such contacting, the introduced gas is purified of contaminants therein, by adsorption on the adsorbent in section 56, and the resulting contaminant-depleted gas is discharged from the lower section of the shroud in the direction indicated by arrows 72, as purified gas.

The tray 52 also is arranged with a thermal regeneration shroud 62 above and below the rotating tray, with the respective upper and lower thermal regeneration shroud sections being in registry with one another, defining an interior volume to which regeneration gas an elevated temperature is introduced in regeneration gas line 66 for flow downwardly in the shroud, from the upper shroud section of the lower shroud section, so that it passes through and is contacted with the adsorbent in the section 54 of the tray. As a result of such contacting, the adsorbent previously loaded with adsorbed contaminant as a result of passing through shroud 64 is heated by the regeneration gas to desorbed the contaminants, so that they are entrained in the thermal regeneration gas stream and are discharged from the lower shroud section of the thermal regeneration shroud and are discharged in discharge line 68.

The contaminant-containing regeneration gas may be discharged to effluent from the gas purification system, or such contaminant-containing regeneration gas may be flowed to a processing unit (not shown) for removal of contaminants from the thermal regeneration gas so that the regeneration gas may then be recirculated and reused in the system.

In the FIG. 2 drawing, the adsorbent in section 58 has just been thermally regenerated in the thermal regeneration shroud flow of regeneration gas, and thereby been renewed for further adsorptive purification use.

Accordingly, as the tray 52 rotates, the adsorbent in each of the sections 54, 56, and 58 passes successively through the gas contacting shroud 64 to effect gas purification, following which it is thermally regenerated in the thermal regeneration shroud 62 by contact with thermal regeneration gas, following which it is passed from the thermal regeneration shroud 62 to the gas contacting shroud 64 4 renewed purification utilization. In this manner, continuous gas purification is achieved, with continuous adsorption of contaminants for gas purification, and continuous desorption of contaminants from the adsorbent, as the tray moves through its full 360° rotational path.

The adsorbent utilized in the FIG. 2 gas purifier apparatus comprises an adsorbent of the present disclosure. For example, the adsorbent may comprise a high purity microporous carbon pyrolyzate adsorbent derived from microcrystalline cellulose, or a blend of microcrystalline cellulose with other pyrolyzable materials such as starches and/or maltodextrin. The adsorbent thus may comprise a pyrolyzate of a combination, e.g., a blend or mixture, of two or more pyrolyzable materials including microcrystalline cellulose, or the adsorbent may comprise a composite pyrolyzate adsorbent including two or more discrete pyrolyzate adsorbents in a blend or mixture with one another. It will be recognized that microcrystalline cellulose-based pyrolyazate adsorbents of the present disclosure may be widely varied in composition and optional additional pyrolyzable source materials and pyrolyzed products.

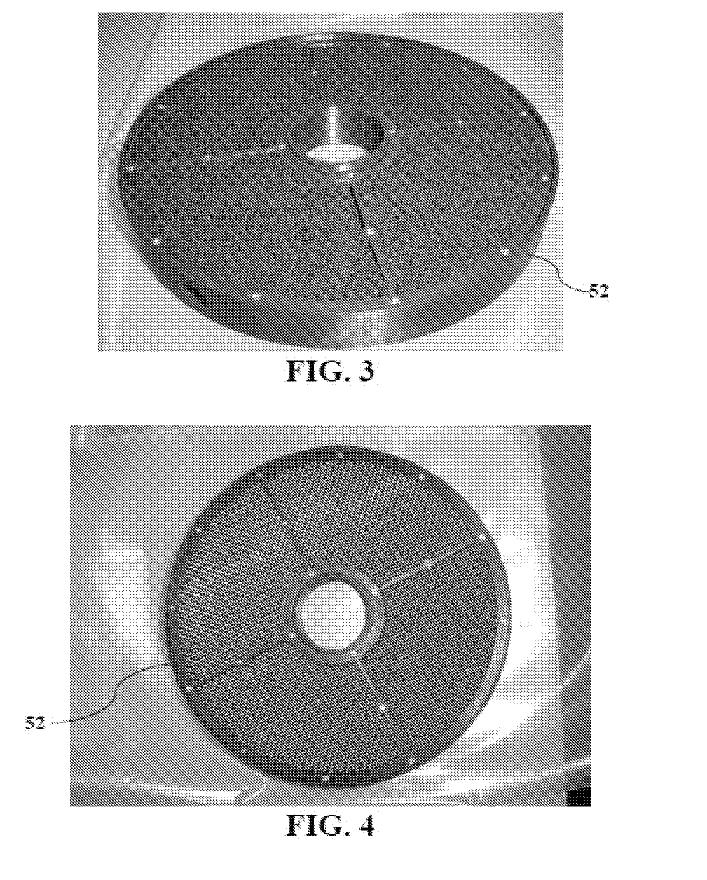

FIG. 3 is a perspective view of a tray 52 of a type as shown schematically in the FIG. 2 gas purifier apparatus, showing the tray filled with granular carbon pyrolyzate adsorbent of the present disclosure. In contrast to the tray shown in FIG. 2, the tray 52 shown in FIG. 3 has a radial wall assembly that divides the volume of the tray into quadrants, each having an arc length of 90°. FIG. 4 is a bottom perspective view of the tray 52 of FIG. 3, showing the 4 of the tray on which the carbon pyrolyzate adsorbent is loaded in the four sections.

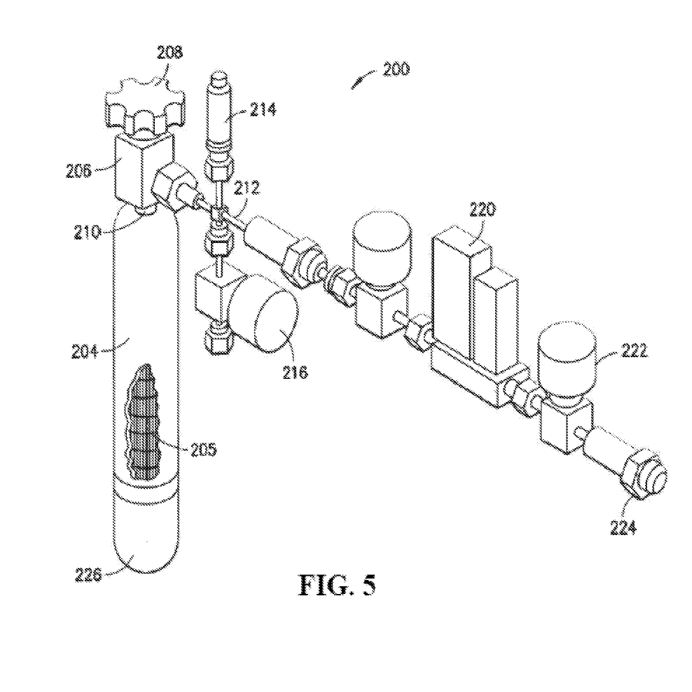

FIG. 5 is a schematic representation of a storage and delivery system 200 comprising a gas supply package utilizing a cellulosic carbon pyrolyzate monolithic adsorbent, according to another embodiment of the present disclosure.

As shown, the storage and delivery system 200 comprises a storage and dispensing vessel 204 that is joined at its upper portion to a valve head 206 comprising part of a dispensing assembly including manual actuator 208 for the valve head on the cylinder. In lieu of such manual actuator, an automatic valve actuator could be employed, such as a pneumatic valve actuator, or actuator of other suitable type.

The valve head contains a valve (not shown) that is translatable between fully open and fully closed positions, to either dispense gas from the vessel 204 when the valve is opened, or to retain gas stored in the vessel 204 when the valve is in a fully closed position. When the valve is open for dispensing, gas can be discharged from the vessel by any suitable modality, including connecting the vessel to flow circuitry in which pressure lower than the pressure in the vessel is maintained, so the gas is desorbed by such dispensing operation and dispensed from the vessel. Additionally, or alternatively, the vessel may be heated to effect desorption of gas, for gas dispensing from the vessel with the valve being open for such dispensing. As another additional, or alternative, mode of operation, a carrier gas can be flowed through the interior volume of the vessel, to effect desorption by the resulting mass transfer concentration gradient between the carrier gas and the adsorbed gas on the carbon pyrolyzate adsorbent material in the vessel.

The vessel 204 can be formed of any suitable material of construction, e.g., comprising material such as metals, glasses, ceramics, vitreous materials, polymers, and composite materials. Illustrative metals for such purpose include steel, stainless steel, aluminum, copper, brass, bronze, and alloys thereof. The valve head is joined by means of coupling 210 to a dispensing conduit 212 having disposed therein a pressure transducer 214, an inert purge unit 216 for purging the dispensing assembly with inert gas, a mass flow controller 220 for maintaining constant flow rate through the dispensing conduit 212 during the dispensing operation, and a filter 222 for removing particulates from the dispensed gas prior to its discharge from the dispensing assembly.

The dispensing assembly further comprises a coupling 224, for matably engaging the dispensing assembly with downstream piping, valving, or other structure associated with the locus of use of the desorbed gas, e.g., a chemical synthesis reactor or a microelectronic product manufacturing tool. The gas storage and dispensing vessel 204 is shown partially broken away to show the interior monolithic cellulosic carbon pyrolyzate adsorbent comprising a vertically extending stack of discs 205, which may constitute a cellulosic carbon pyrolyzate material of the present disclosure, having suitable porosity and physical characteristics. The discs 205 may be of a same or similar diameter (transverse dimension, perpendicular to the longitudinal axis of the vessel 204), with successively adjacent stacked discs in the stack abutting one another in face-to-face contact.

The successive discs in the stacked array of discs in the vessel interior volume may each be of a cylindrical form, with circular end faces that fully abut circular end faces of adjacent discs in the stack, or the discs may alternatively be beveled on their edges, or have channels on their periphery to facilitate gas ingress and egress throughout the stack of adsorbent articles.

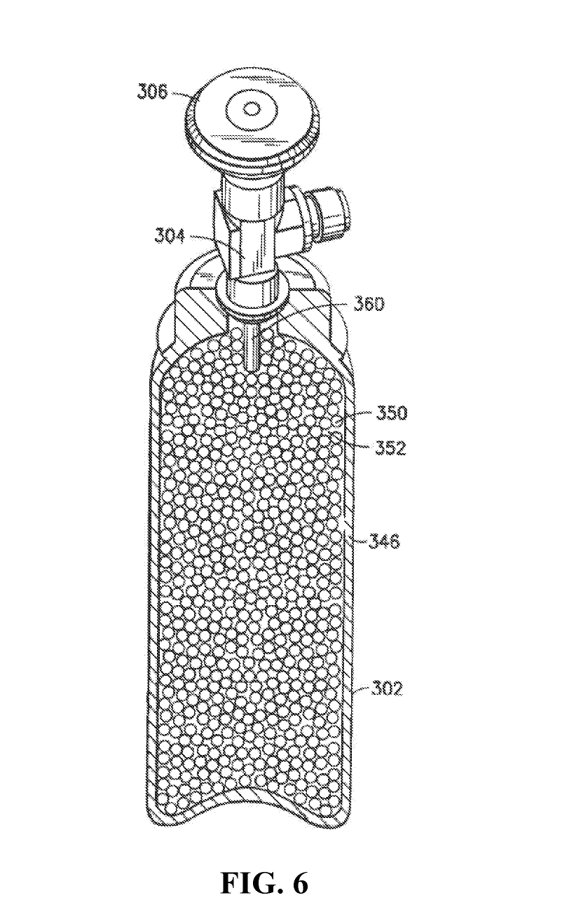

FIG. 6 is a perspective cross-sectional view of a gas supply package including a gas storage and dispensing vessel 302, showing the interior structure of such vessel, as containing a particulate cellulosic carbon pyrolyzate adsorbent, according to a further embodiment of the disclosure.

As shown, the vessel 302 comprises a wall 346 enclosing an interior volume 352 of the vessel, and containing a particulate cellulosic carbon pyrolyzate adsorbent 350 in accordance with the present disclosure, e.g., in the form of spherical beads of adsorbent. At the upper end of the vessel, at the port to which the valve head 304 is joined, a porous sintered tube 360, or other gas-permeable structure, may be provided, serving to prevent entrainment in the dispensed gas of particulate solids from the bed of the cellulosic carbon pyrolyzate adsorbent material. The valve head 304 is coupled with a manual valve actuator wheel 306, by which the valve (not shown) in the valve head 304 may be manually translated between fully open and fully closed positions, for dispensing in the open position, and gas storage in the vessel, in the fully closed position.

Thus, the disclosure contemplates a gas supply package, comprising a gas storage and dispensing vessel containing a cellulosic carbon pyrolyzate adsorbent for reversibly retaining gas thereon in an adsorbed state, and desorbing gas for discharge from the vessel under dispensing conditions of the gas supply package.

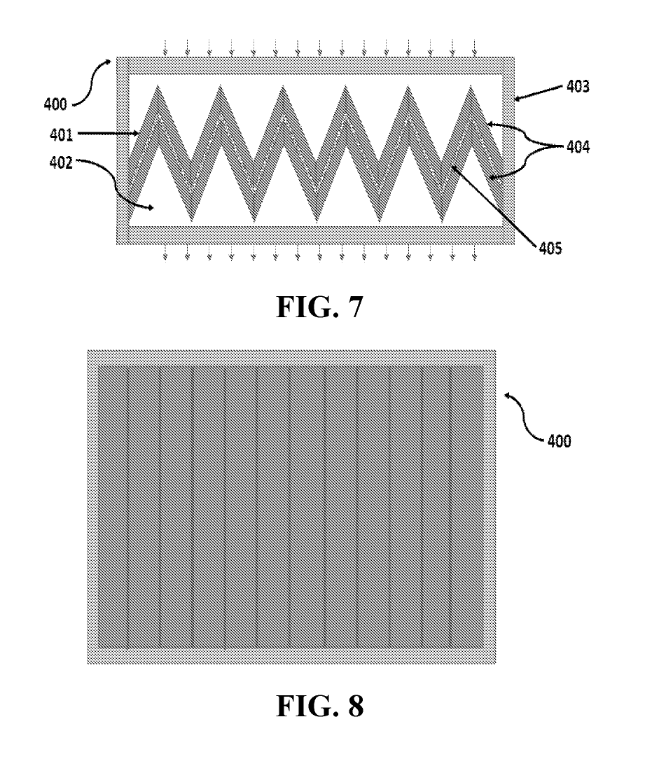

FIG. 7 is a sectional elevation view of a gas filter system 400 according to one embodiment of the present disclosure. The gas filter system 400 as shown includes an open top face through which gas to be purified flows in the direction indicated by the upper arrows, flowing through the interior volume 402 of the housing 403 and being discharged at the open bottom face of the housing, in the direction indicated by the lower areas arrows in such drawing. In the interior volume 402 is disposed a filter assembly 401 comprising upper and lower layers 404 of a fibrous filter material, intermediate which is a layer of the microcrystalline cellulose pyrolyzate adsorbent 405 in accordance with the present disclosure. The microcrystalline cellulose pyrolyzate adsorbent may comprise a layer of granular particles of the adsorbent, sandwiched between the respective upper and lower layers 404 of the fibrous filler material, and optionally held in place by a thin film adhesive layer on the adsorbent-contacting faces of the fibrous filler material. Any such thin film adhesive layer should be of such character has not to significantly occlude porosity of the adsorbent, in order that the pore volume and sorptive surface area of the adsorbent are maximized for gas-purification service.

FIG. 8 is a top plan view of the gas filter system 400 of FIG. 7, showing the top inlet face of the system. By the arrangement shown in the gas filter system of FIGS. 7 and 8, the gas to be purified flows into the interior volume through the open inlet face and contacts the layers 404 of fibrous filter material to provide for physical filtration of the gas being purified, while the microcrystalline cellulose pyrolyzate adsorbent functions to sorptively remove adsorbable contaminants from the gas being purified, to yield a contaminants-depleted gas that can then be discharged from the housing and circulated or otherwise utilized for its intended purpose.

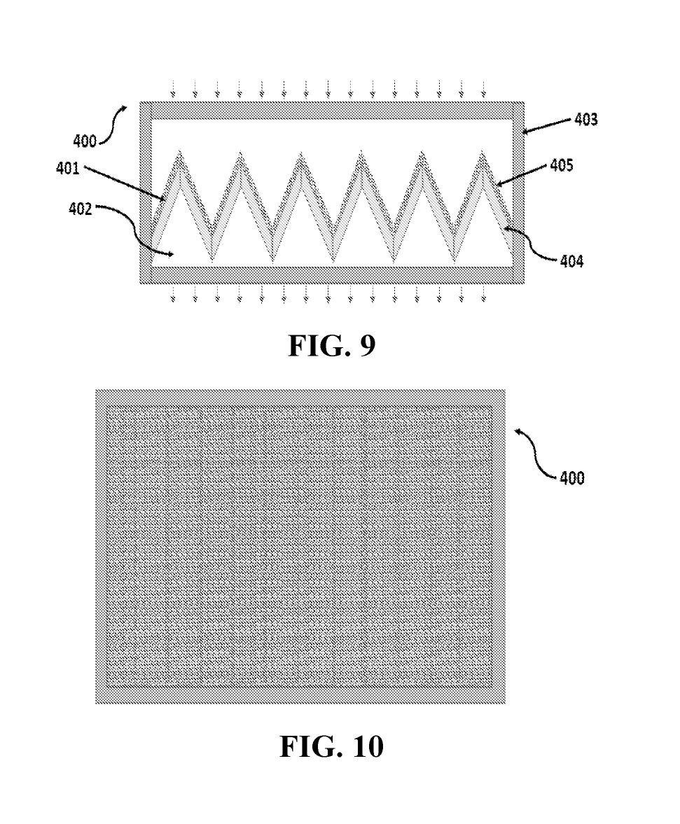

FIG. 9 is a sectional elevation view of a gas filter system 400 according to another embodiment of the present disclosure, wherein all parts and components are numbered correspondingly to FIG. 7, but wherein, in contrast to the gas purification system of FIG. 7, the filter assembly 401 comprises the layer of granular particles of the microcrystalline cellulose pyrolyzate adsorbent 405 on the inlet-facing surface of the layer 404 of fibrous filter material, so that the gas to be purified is contacted first with the adsorbent, which then flows through the fibrous filter material layer 404. In the FIG. 9 embodiment, the microcrystalline cellulose pyrolyzate adsorbent may be coated on the inlet-facing surface of the fibrous filter material layer, and as mentioned above, the fibrous filter material layer may have a thin film layer of adhesive thereon to secure the particulate pyrolyzate adsorbent on the inlet-facing surface of the fibrous filter material layer.

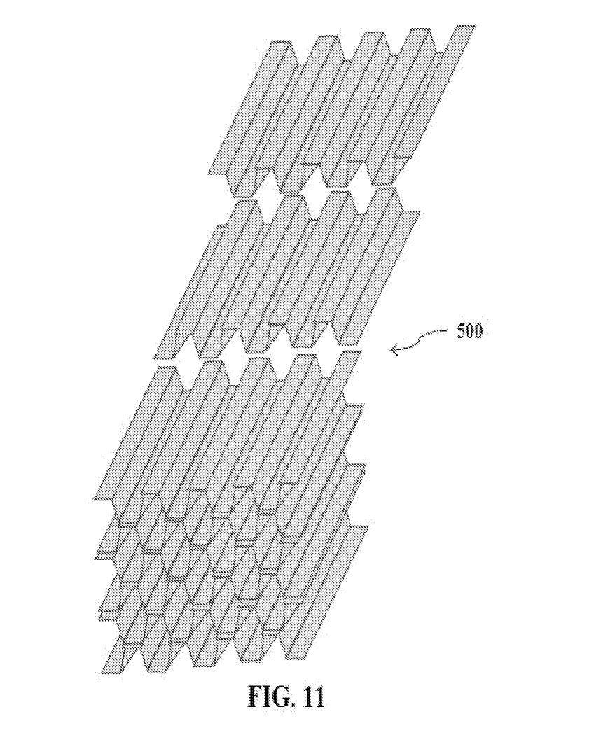

FIG. 10 is a top plan view of the gas filter system 400 of FIG. 9, showing the filter assembly presented to the illustrated inlet face of the system.

FIG. 11 is a schematic partially exploded perspective view of an array 500 of corrugated polymer film sheets. Each of the sheets has the conformation shown, including flat top and bottom panels that are vertically displaced from one another and interconnected by angularly oriented sidewalls. Each of such sheets may thus be matably engaged with another of such sheets, by abuttingly positioning the bottom panel of a first upper sheet in engagement with the top panel of a second lower sheet, so that the same-sized bottom and top panels of the respective sheets are mated and coextensive with one another.

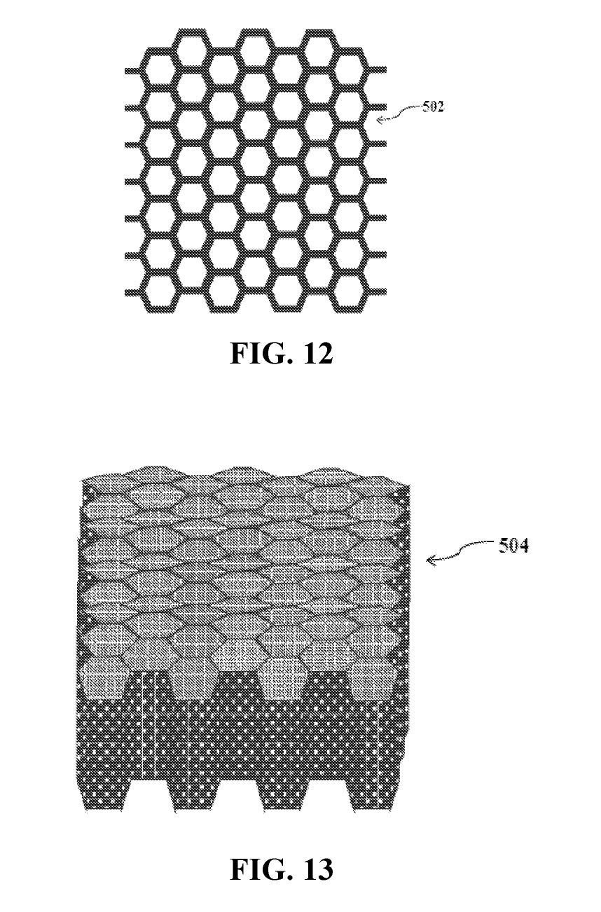

FIG. 12 is a front elevation view of the array 502 after fusing/bonding and pyrolysis of the array 500 shown in FIG. 11, and such array 502 may be filled with pyrolyzable microcrystalline cellulose material optionally in mixture or combination with other pyrolyzable material, with such filled array then being pyrolyzed and activated to form the activated carbon honeycomb array 504 shown in FIG. 13. Alternatively, the array 500 of corrugated polymer film sheets after mating thereof may be filled with the pyrolyzable microcrystalline cellulose material optionally in mixture or combination with other pyrolyzable material, and the entire filled array may be simultaneously pyrolyzed in the first instance, followed by activation of the carbon pyrolyzate.

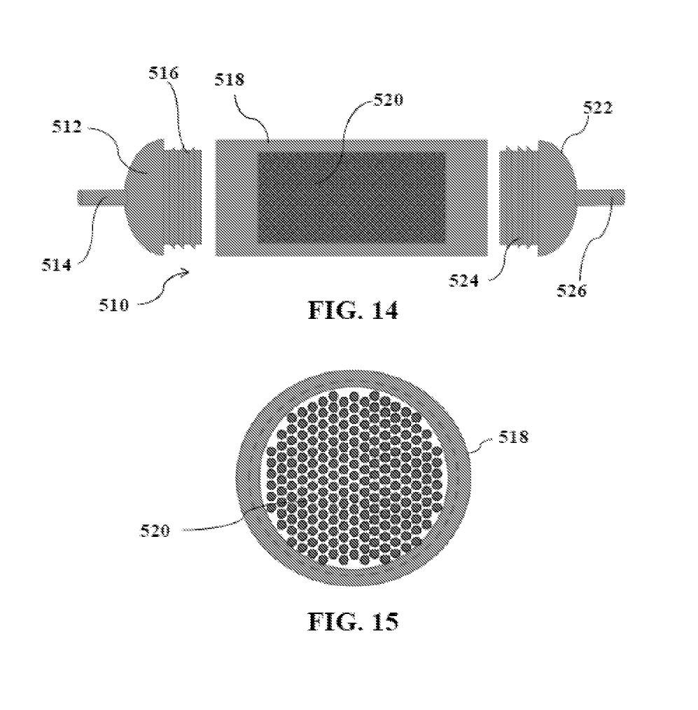

FIG. 14 is an exploded, partial sectional view of a microporous pyrolyzate carbon purifier apparatus according to one embodiment of the present disclosure. The purifier apparatus 510 includes a cylindrical housing 518 containing a microcrystalline cellulose pyrolyzate adsorbent 520 of the present disclosure disposed in the interior volume of the housing 518. The cylindrical housing 518 is threaded on its interior surfaces at both end portions, to accommodate inlet and outlet components of the apparatus. The inlet 512 is provided with an inlet tube 514 for coupling with a conduit, pipe, or other coupling connection in flow circuitry supplying gas to be purified to the apparatus. The inlet 512 is provided with a threaded portion 516 for threadable engagement with the threading on the interior of the associated end portion of the cylindrical housing. In like manner, the outlet 522 is provided with an outlet tube 526 for coupling with flow circuitry for discharge of the purified gas from the apparatus. The outlet 522 is provided with a threaded portion 524 for threadable engagement with the threading on the interior of the associated end portion of the cylindrical housing.

The housing, inlet, and outlet of the purifier apparatus 510 shown in FIG. 14 may be molded, machined, or otherwise formed from any appropriate materials of construction, e.g., of metal such as stainless steel, or polymer such as polyvinylbutyral or polyimide.

FIG. 15 is a cross-sectional view, taken in a plane transverse to the longitudinal axis of the purifier apparatus 510 of FIG. 14, showing the microcrystalline cellulose pyrolyzate adsorbent 520 disposed in the interior volume of the housing 518.

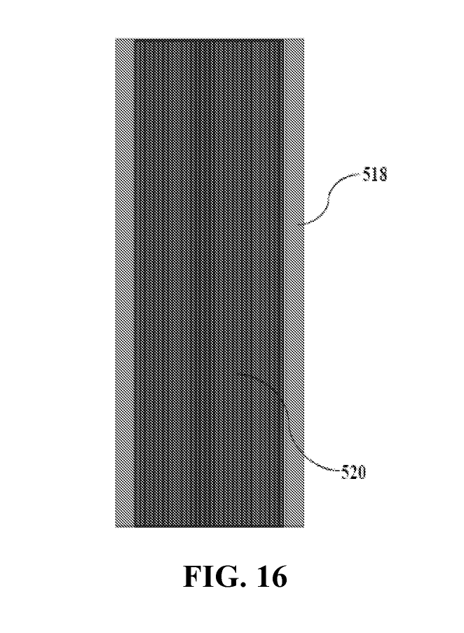

As illustrated, cylindrical rods of adsorbent may be used to fill the interior volume of the housing for advantageous gas flow characteristics and efficient adsorption/desorption kinetics. FIG. 16 is a cross-sectional view of the purifier apparatus (in vertical orientation) in a plane intersecting the central longitudinal axis of the purifier apparatus, showing the microcrystalline cellulose pyrolyzate adsorbent 520 disposed in the interior volume of the housing 518.

It will be appreciated that in lieu of cylindrical rods, the adsorbent may be provided in the interior volume of the purifier housing in any suitable form or conformation, e.g., hexagonal, octagonal, or other cross-sectional shape of rods, or other forms of discrete adsorbent articles, or mixtures and combinations of adsorbents and/or adsorbent articles.

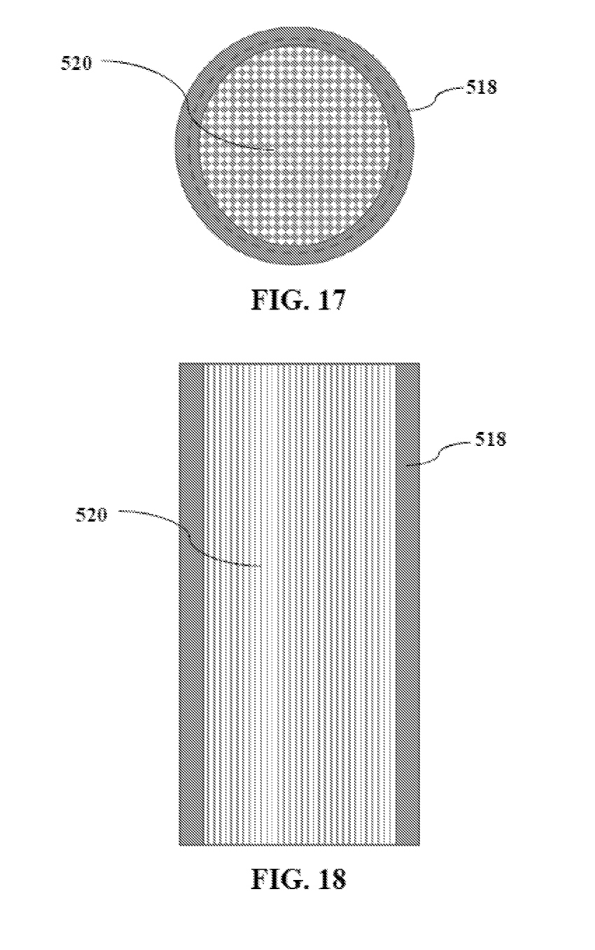

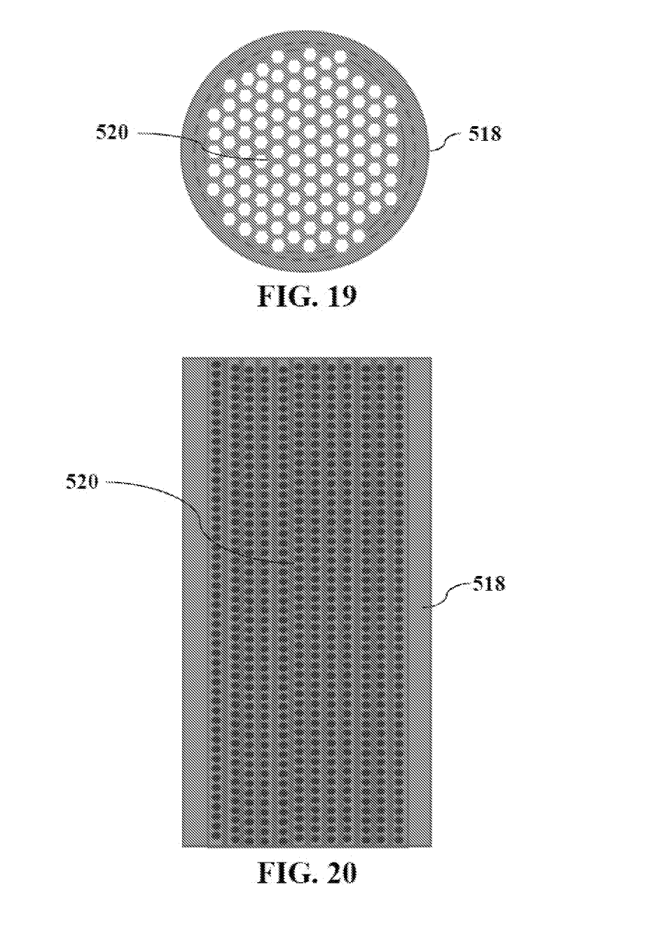

FIG. 17 is a cross-sectional view of a purifier apparatus, taken in a plane transverse to the longitudinal axis of a purifier apparatus of a type as shown in FIG. 14, showing the microcrystalline cellulose pyrolyzate adsorbent 520 in the form of an extruded channeled monolith in the purifier housing 518, with FIG. 18 showing a cross-sectional view of the purifier apparatus (in vertical orientation) in a plane intersecting the central longitudinal axis of the purifier apparatus, to illustrate the channels in the extruded monolith. The longitudinal channels in the monolith may be formed in a suitable manner, as for example by extrusion of the microcrystalline cellulose optionally in combination with other pyrolyzable material, through a forming die in which the pyrolyzable material passes through an array of rod elements so that the extrudate correspondingly has open channels mirroring the rod element array. Other channel-forming methods may be employed, such as laser ablation or micromechanical machining

FIG. 19 is a cross-sectional view of a purifier apparatus, taken in a plane transverse to the longitudinal axis of a purifier apparatus of a type as shown in FIG. 14, and FIG. 20 is a cross-sectional view of the purifier apparatus (in vertical orientation) in a plane intersecting the central longitudinal axis of the purifier apparatus, showing the microcrystalline cellulose pyrolyzate adsorbent 520 in the form of particulate adsorbent in a honeycomb structure in the purifier housing 518. Thus, the fine channels can be formed as a honeycomb structure that subsequently is filled with stacked adsorbent articles, as illustrated in FIG. 20.

It will be apparent from the foregoing that the gas purifier apparatus of the present disclosure may be constructed and arranged in any of a variety of configurations, and that the microcrystalline cellulose pyrolyzate adsorbent may be provided in the housing for gas contacting with the gas to be purified, in any suitable form, including divided form such as powders, particles, granules, beads, or the like, or bulk forms such as monolithic adsorbent articles.

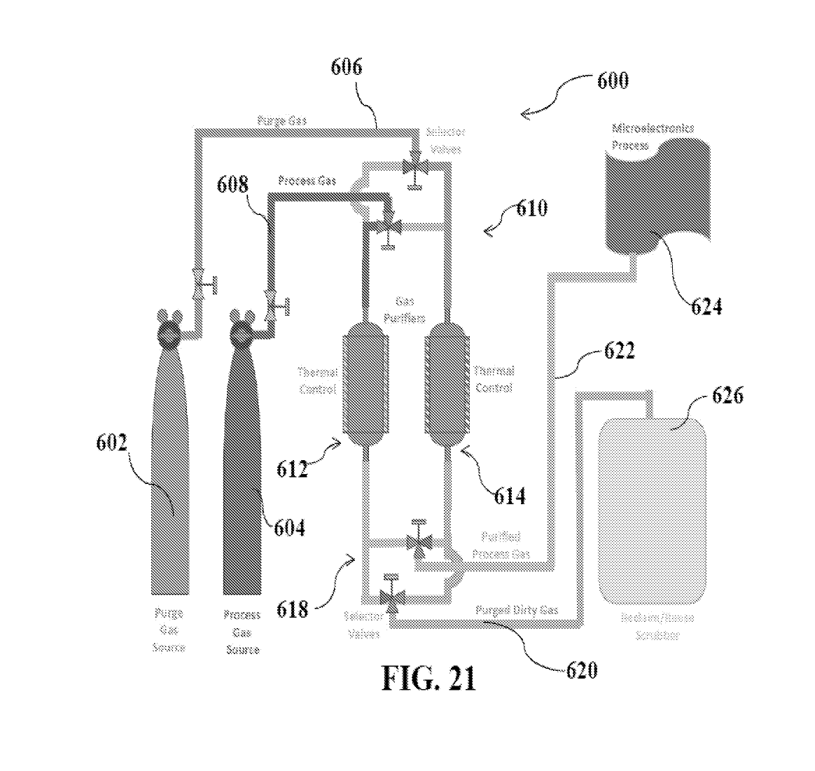

FIG. 21 is a schematic representation of a gas delivery system 600 according to one embodiment of the present disclosure, for a microelectronics manufacturing process facility 624. The gas delivery system includes a purge gas source 602, which may comprise a fluid storage and dispensing vessel equipped with a valve head assembly, and coupled with purge gas line 606 containing a flow control valve therein, for delivery of purge gas to the inlet manifold 610 associated with the array of purifier vessels 612 and 614 each containing a microcrystalline cellulose pyrolyzate adsorbent in accordance with the present disclosure. The inlet manifold 610 contains selector valves for routing gas flows in the manifold to one of the selected purifier vessels 612 and 614. The purifier vessels 612 and 614 thus are coupled with the inlet manifold 610, and such vessels are also coupled with an outlet manifold 618 likewise containing selector valves for routing of gas flows, in the operation of the gas delivery system.

The gas delivery system also includes a process gas source 604, which may be constructed in a manner corresponding or analogous to that of purge gas source 602, with a fluid storage and dispensing vessel equipped with a valve head assembly, and coupled with the process gas feed line 608 containing a flow control valve therein, for delivery of process gas to the inlet manifold 610 associated with the array of purifier vessels 612 and 614 containing the microcrystalline cellulose pyrolyzate adsorbent.

The purifier vessels are arranged for cyclic alternating purification of process gas from the process gas source 604, with an on-stream one of the purifier vessels being supplied with process gas from process gas source 604, while the other, off-stream one of the purifier vessels is being regenerated with gas from the purge gas source 602, by flow of purge gas through the off-stream vessel to effect desorption of adsorbed contaminants from the adsorbent in such off-stream vessel, and after such regeneration of the vessel renewed for further purification service may be switched to on-stream processing of the process gas, or alternatively, the regenerated vessel may be placed on stand-by status until gas purification has been completed in the other purifier vessel. The gas purification step may be carried out until the adsorbent in the purifier vessel is loaded to an appropriate level of contaminants from the process gas supplied from the process gas source 604, before on-stream processing is switched to the other, regenerated your fire vessel. The vessels may be equipped with heating jackets or other thermal controls, to effect heating of the off-stream vessel, to thereby assist the desorption of contaminants from the previously on-stream one of the purifier vessels.

Thus, by the illustrated arrangement of valve inlet and valve outlet manifolds, the gas purifiers are arranged so that the on-stream one of the purifier vessels receives the process gas to be purified from the process gas source 604, and the resulting purified gas from the on-stream vessel then is discharged to the outlet manifold, which by appropriate setting of the selector valves directs the purified process gas into the purified process gas delivery line 622 for flow to the microelectronics process facility 624. The off-stream vessel is regenerated by flow of purge gas therethrough to effect desorption of contaminants from the adsorbent, optionally assisted by heat input to the vessel being regenerated, to further enhance the rate and extent of desorption, and the resulting contaminants-containing purge gas then is flowed in contaminants-containing purge gas line 622 the reclaim/reuse scrubber 626, in which the contaminants may for example be removed from the purge gas by catalytic oxidation, but scrubbing, dry scrubbing, chemical reaction, capture and solubilization in a disposal medium, or in other manner, to regenerate the purge gas for recycle and reuse in the system. Alternatively, the scrubber may simply treat the purge gas to remove the contaminants therefrom, with the resulting cleaned purge gas being discharged to receiving air or waters, or otherwise disposed of.

The purge gas may be of any suitable type, and may for example comprise air or an inert gas such as nitrogen, argon, krypton, helium, xenon, or the like, or other purge gas that is effective for removing the contaminants from the purge gas containing same.

By the arrangement shown, the selector valves in the inlet and outlet manifolds may be cyclically switched according to a cycle time or program or modulated in other manner to achieve a continuous or otherwise desired mode of operation of the gas delivery system.

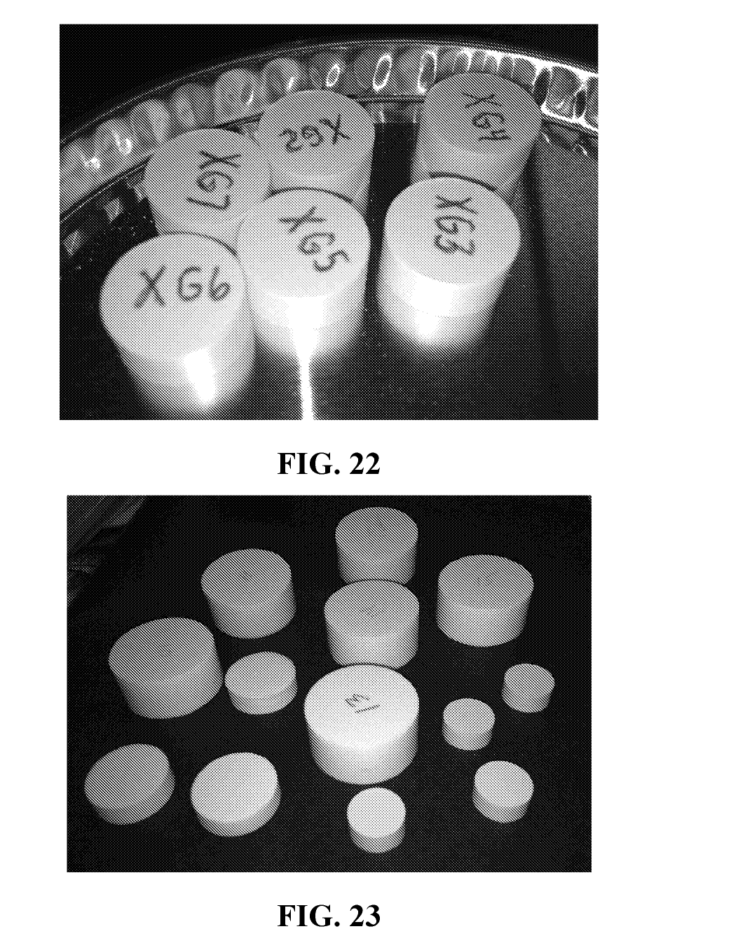

As previously discussed herein, it will be appreciated that the cellulosic carbon pyrolyzate materials of the present disclosure may be utilized together with non-cellulosic carbon pyrolyzate materials, such as those shown and described with reference to FIGS. 22-23 and the Examples 1-3 set out hereafter.

FIG. 22 is a photograph of self-adherent tablets of natural carbohydrate formed by direct compression, without an added binder, and having a raw material density in excess of 1.32 g/cc.

FIG. 23 is a photograph showing a range of sizes of disks compressed from various natural carbohydrate sources.

The features and characteristics of non-cellulosic carbon pyrolyzate materials are more fully illustrated by the following non-limiting Examples 1-3.

### EXAMPLE 1

A supply of natural corn starch was obtained and a sample of the starch taken from this supply was weighed and heated to 195° C. in a laboratory air oven to dry and stabilize such precursor material. The dried starch was then pyrolyzed under flowing nitrogen in a tube furnace at 600° C. After cooling, the N₂ BET surface area of the corn starch-derived carbon pyrolyzate was determined as 578 m² per gram, using a Micromeritics ASAP 2420 Porosimeter.

Another sample of the corn starch from the same supply was weighed and compressed into tablet form under pressure of approximately 0.17 mPa (25,000 psi) to obtain preform tablets. The tablets were weighed and measured to enable determination of a piece density for each. The compressed corn starch tablets had an average piece density of 1.20 grams/cc.

These corn starch tablets were then pyrolyzed under flowing nitrogen in a tube furnace at temperature of 600° C. After cooling, the resulting carbon tablets were weighed and measured, and their piece density was calculated. The average piece density of the corn starch-derived carbon tablets was 0.90 grams/cc. The corn starch-derived carbon tablets were analyzed for N₂ BET surface area and found to have surface area of 431 m² per gram. Then the corn starch-derived carbon tablets were reloaded into the tube furnace and heated to 600° C. in flowing nitrogen. Next, the carbon tablets were further heated to 735° C. at which temperature they were exposed to flowing CO₂ for a period determined to be adequate for a 20-25% burn-off (oxidative weight loss), and then the carbon tablets were cooled in nitrogen to room temperature.

After this physical oxidative activation, the density of the carbon tablets was measured as 0.78 grams/cc. The activated carbon tablets then were measured for N₂ BET surface area and found to have surface area of 890 m² per gram.

### EXAMPLE 2

A supply of industrial corn starch-derived maltodextrin was obtained. A sample of the maltodextrin was weighed and heated in a laboratory air oven to dry and stabilize the sample at temperature of 235° C. The dried maltodextrin was then pyrolyzed under flowing nitrogen in a tube furnace at temperature of 600° C. After cooling, the corn starch-derived maltodextrin carbon was analyzed for N₂ BET surface area using a Micromeritics ASAP 2420 Porosimeter. A surface area of 465 m² per gram was determined.

Another sample of the same corn starch-derived maltodextrin was weighed out and compressed into cylindrical tablet form under approximately 185.2 MPa (˜26,857 psi) to obtain preform tablets. The tablets were weighed and measured so that a piece density could be calculated. The compressed maltodextrin tablets had an average piece density of 1.36 grams/cc. A number of the cassava starch tablets were pyrolyzed under flowing nitrogen in a tube furnace at temperature of 600° C. After cooling, the resulting carbon tablets were weighed and measured, and the piece density was calculated. The average piece density of the corn starch-derived maltodextrin carbon tablets was 1.06 grams/cc. The corn starch-derived maltodextrin carbon tablets were analyzed for N₂ BET surface area and found to have surface area of 588 m² per gram.

The corn starch-derived maltodextrin carbon tablets were reloaded into the tube furnace and heated to 600° C. in flowing nitrogen, and then further heated to 950° C. while exposed to flowing CO₂ for just 3 hours to a level of 49.9% wt burn-off, following which the tablets were cooled in nitrogen to room temperature. After this physical oxidative activation, the density of the carbon tablets was reduced to 0.76 grams/cc. The activated carbon tablets were again measured for N₂ BET surface area and surface area was determined to have risen to 1581 m² per gram. Subsequent measurement of methane adsorption on this adsorbent showed a capacity of 152.5 cc CH₄/g at 21° C. and 35 bar pressure which yielded an absolute CH₄ working capacity between 35 bar and 1 bar pressure of 121 V/V.

### EXAMPLE 3

Cylindrical tablets combining varied ratios of the native corn starch discussed in Example 1 mixed with the corn starch-derived maltodextrin discussed in Example 2 were formed under a range of compressive conditions between 28 and 338 MPa (˜4050 psi to 49,000 psi) to obtain preform tablets. The tablets were weighed and measured and evaluated in several ways for strength and other important physical properties.

The blended materials followed a very linear rule of mixtures relationship to the properties obtained with either the pure corn starch or the pure maltodextrin.

Upon pyrolysis to 600° C. this adherence to the rule of mixtures was maintained. Thus it was determined that blending of maltodextrin and corn starch, or likely any of the natural starches, at the optimal ratios could take advantage of the beneficial qualities of each of these materials. Some of the more common natural carbohydrates that were found to give excellent properties and performance included starches of corn, potato, wheat, and cassava.

Table 1 below summarizes the properties of several of the embodiments described herein.

TABLE 1
Measured Properties of Active Carbon Monolith Tablets Prepared from Carbohydrates

| | | | | | | | | | | Absolute |
|---|---|---|---|---|---|---|---|---|---|---|
| | | | | | | | | | | CH4 |
| | | As Pyrolyzed | | | | | | | Total CH4 | Working |
| | | N₂ BET | CO₂ | Burn- | | N₂ BET | N₂ BET | D-R | Adsorption | Capacity - |
| | Source | S.A. - | Activation | Off - | Density - | S.A. - | S.A. - | MPV - | Capacity - | cm³/cc |
| Sample # | Material | m²/cc | Conditions | % wt | g/cc | m²/g | m²/cc | cc/g | cm³/cc | 35 bar-1 bar |
| N0190-25-50A | Potato Starch | 459 | 8 hrs @ 775 C. | 25.9 | 0.96 | 910 | 874 | 0.3616 | 104 | 81 |
| N0190-37-PS | Potato Starch | 475 | 30 hrs @ 775 C. | 39.9 | 0.86 | 1210 | 1045 | 0.4881 | 187.2 | 106 |
| N0190-72-WT | Wheat Starch | 513 | 16 hrs @ 800 C. | 29.4 | 0.82 | 1321 | 1083 | 0.5771 | 136.5 | 107 |
| N0190-71-PB | Native Corn | 537 | 14 hrs @ 775 C. + | 30.5 | 0.86 | 1251 | 1076 | 0.5044 | 134.4 | 103 |
| | Starch | | 8 hrs @ 800 C. | | | | | | | |
| N0190-57-CC | Cassava Starch | 545 | 13 hrs @ 775 C. | 47.4 | 0.64 | 1323 | 845 | 0.3289 | 122.7 | 97 |
| N0190-82-MD | 10DE | 588 | 3 hrs @ 950 C. | 49.9 | 0.76 | 1581 | 1195 | 0.6373 | 152.5 | 121 |
| | Maltodextrin | | | | | | | | | |

### EXAMPLE 4

Several samples of the starch-derived carbons were selected for testing of boron trifluoride adsorption capacity, as this large flat molecule provides good assessment of slit-shaped porosity in microporous carbons. All the starch-derived carbon samples had been pyrolyzed under flowing nitrogen in a tube furnace at a temperature of 600° C. Each was then oxidatively activated in CO₂ at temperatures between 600° C. and 1000° C. to boost surface area to greater than 1000 square meters per gram.

The starch-derived carbon tablets were each analyzed for level of burn-off, tablet density, and N₂ BET surface area. Then the tablets were tested for boron trifluoride adsorption capacity and deliverables at 21° C. in vacuum swing operation simulating conditions that an implant dopant gas application would employ. Results were compared to a representative sample of PVDC-derived carbon adsorbent.

Table 2 shows the results of this work. It can be seen that high surface area carbon adsorbents derived from a variety of starches and maltodextrin can achieve similar gravimetric adsorption capacity for BF₃ as that demonstrated by the PVDC carbon. The ability to deliver much of that adsorbed BF₃ to a vacuum process, such as an ion implanter, was also demonstrated by adsorbing gas up to equilibration at approximately 725 Torr and desorbing back down to 20 Torr at isothermal conditions of 21° C. to determine working capacity.

TABLE 2
Boron Trifluoride Capacity Data for Selected Carbohydrate Derived Carbon Adsorbents

| | | | CO₂ | | | | | | BF₃ wt % |
|---|---|---|---|---|---|---|---|---|---|
| | | Pyrolysis | Activation | | | | | 21 C. BF₃ Ads. | Working |
| Carbon | Source | Temp. | Temp. | Denisty | Burn-Off | N₂ BET S.A. | N₂ BET S.A. | Capacity | Capacity |
| Sample No. | Material | (C.) | (C.) | (g/cc) | (% wt) | (sq. m/g) | (sq. m/cc) | (wt %) | @21 C. |
| N0190-23-PT2 | Potato Starch | 600 | 900 | 0.69 | 47.8 | 1571 | 1084 | 28.2 | 16.5 |
| N0190-57-CC58 | Cassava Starch | 600 | 775 | 0.64 | 47.4 | 1327 | 849 | 34.6 | 15.3 |
| N0190-71-P817 | Corn Starch | 600 | 800 | 0.86 | 30.5 | 1270 | 1092 | 28.4 | 15.1 |
| N0190-72-WT15 | Wheat Starch | 600 | 800 | 0.82 | 29.4 | 1437 | 1178 | 37.5 | 15.0 |
| N0190-77-A825 | 10DE | 600 | 775 | 0.93 | 37.8 | 1169 | 1087 | 20.4 | 11.3 |
| | Maltodextrin | | | | | | | | |
| HF02-34 | PVDC | | | 1.12 | | 1030 | 1154 | 23.3 | 11.9 |

In similar fashion, a series of natural carbohydrate derived carbon samples were activated and selected for testing of arsine adsorption capacity. All were pyrolyzed at 600° C. under inert gas then activated in CO2 at temperatures between 700° C. and 1000° C. Evaluation of samples followed a similar routine to that described for boron trifluoride. Arsine adsorption results are shown in Table 3.

TABLE 3
Arsine Capacity Data for Selected Carbohydrate Derived Adsorbents

| | | | | | | | | 21 C. AsH₃ | AsH₃ cc/cc |
|---|---|---|---|---|---|---|---|---|---|
| | | | CO₂ | | | | | Ads. | Working |
| Carbon | | Pyrolysis | Activation | Denisty | Burn-Off | N₂ BET S.A. | N₂ BET S.A. | Capacity | Capacity |
| Sample No. | Source Material | Temp. (C.) | Temp. (C.) | (g/cc) | (% wt) | (sq. m/g) | (sq. m/cc) | (cc/g) | @21 C. |
| N0190-54-PP52 | Potato Starch | 600 | 775 | 0.78 | 38.9 | 1160 | 905 | 121 | 83 |
| N0190-57-CC30 | Cassava Starch | 600 | 775 | 0.49 | 64.3 | 1747 | 856 | 198 | 92 |
| N0190-71-PB16 | Corn Starch | 600 | 800 | 0.77 | 39.3 | 1272 | 979 | 166 | 118 |
| N0190-72-WT16 | Wheat Starch | 600 | 800 | 0.75 | 37.8 | 1431 | 1073 | 193 | 134 |
| N0190-72-AB33 | 10DE Maltodextrin | 600 | 800 | 1.16 | 16.3 | 843 | 978 | 97 | 95 |
| HF02-36 | PVDC | | | 1.12 | | 1025 | 1148 | 145 | 134 |
| N0190-66-WS63 | Wheat Starch | 600 | 775 | 1.04 | 23.9 | 848 | 882 | 117 | 110 |
| N0190-66-WS82 | Wheat Starch | 600 | 775 | 0.96 | 30.5 | 973 | 938 | 134 | 118 |
| N0190-72-WT11 | Wheat Starch | 600 | 800 | 0.66 | 41.7 | 1529 | 1011 | 204 | 128 |
| N0190-72-WT26 | Wheat Starch | 600 | 800 | 0.84 | 29.5 | 1200 | 1006 | 162 | 127 |
| N0190-72-WT28 | Wheat Starch | 600 | 800 | 0.86 | 26.7 | 1124 | 962 | 153 | 124 |
| N0190-77-WT00 | Wheat Starch | 600 | 925 | 0.47 | 53.8 | 1760 | 827 | 233 | 105 |
| N0190-77-WT06 | Wheat Starch | 600 | 850 | 0.72 | 31.7 | 1122 | 807 | 151 | 103 |
| N0190-77-WS95 | Wheat Starch | 600 | 775 | 0.87 | 31.0 | 1002 | 873 | 139 | 113 |

### EXAMPLE 5

Cellulosic as well as non-cellulosic precursor materials were evaluated for forming of carbon pyrolyzate materials useful as adsorbents. Microcrystalline cellulose was evaluated, along with sugars, starches, chitin, chitosan, pectin, and maltodextrin, as precursor materials. Microcrystalline cellulose materials considered in this effort included anhydrous cellulose microcrystalline powder having crystal size of approximately 50 μm, commercially available from Acros Organics (Thermo Fisher Scientific, http://www.acros.com), and from Microcrystalline Cellulose—Ultra Pure Powder (Avicel® PH-101, Sigma-Aldrich Co., LLC).

The microcrystalline cellulose was utilized to make microporous carbon pyrolyzate material in both powder and tablet form. Under the right conditions, the material was found to form strong, solid tablets via direct compression (without use of a binder) and the tablet structure was sufficiently open so that that byproduct gases during thermal decomposition could escape the structure readily without significantly swelling or damaging the formed pieces. Resulting carbon pyrolyzate tablets were strong and appeared to have good gas permeability and were found to be readily activated with CO₂. Representative carbon pyrolyzate tablets exhibited the following properties: ˜400-600m²/g N₂ BET surface area as pyrolyzed; ˜1100-1500m²/g N₂ BET surface area at ˜25%-40% burn-off (˜19%-15% yield); a pyrolyzed density of ˜0.90-1.15 g/cc; an activated density of ˜0.67-0.90 g/cc; and a permeability constant K of ˜1-2×10⁻¹⁴ m².

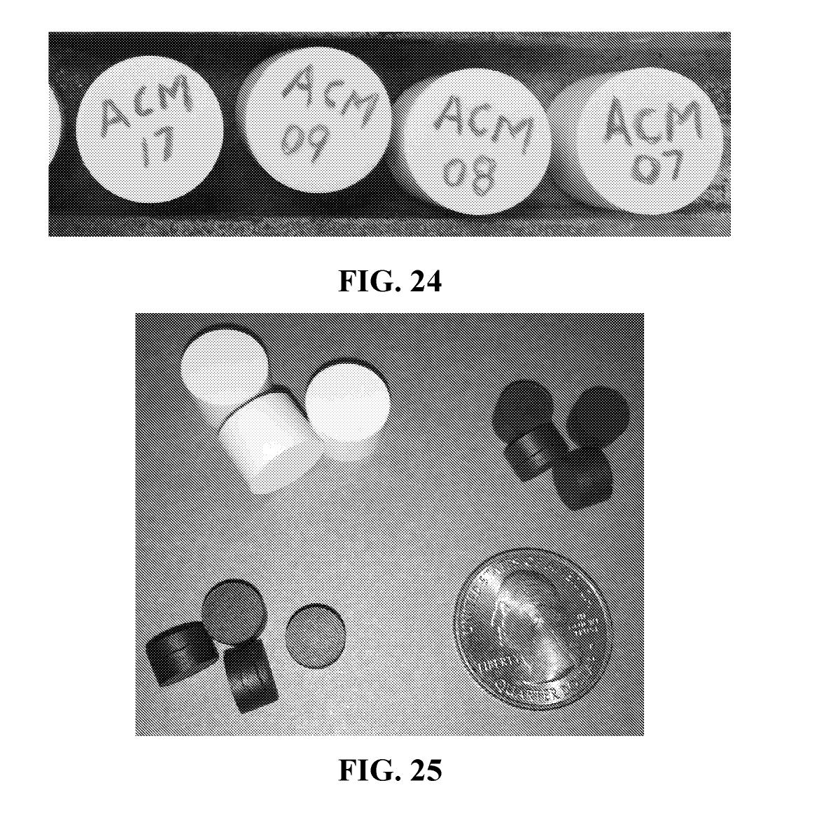

The microcrystalline cellulose was processed as follows. Round tablets were prepared using a Carver Laboratory Press and a 0.5″ diameter stainless steel die mold. Each tablet was made to be approximately 1.5 g and pressed under approximately 14,000-28,000 psi load pressure for hold times ranging from 60 seconds to 30 minutes. All tablets were judged to be satisfactory in appearance. Such tablets are shown in FIGS. 24 and 25. Densities were measured and ranged from approximately 1.00-1.35 g/cc. The pressed tablets had a height of ˜8.5-9.5 mm. No obvious advantage was observed for the 30 minute press hold versus the 60 second press hold, and no obvious advantage was observed for the 28,000 psi press loading versus the 14,000 psi press loading.

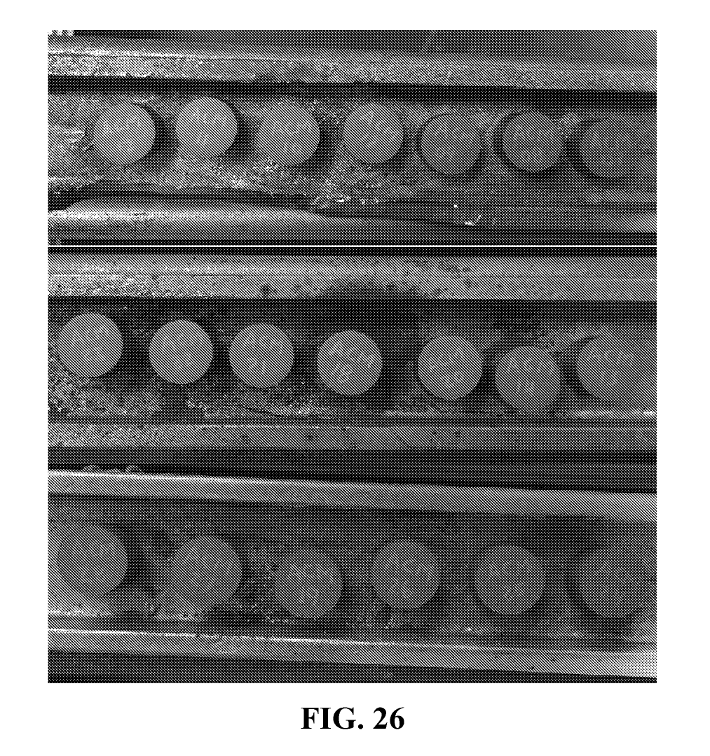

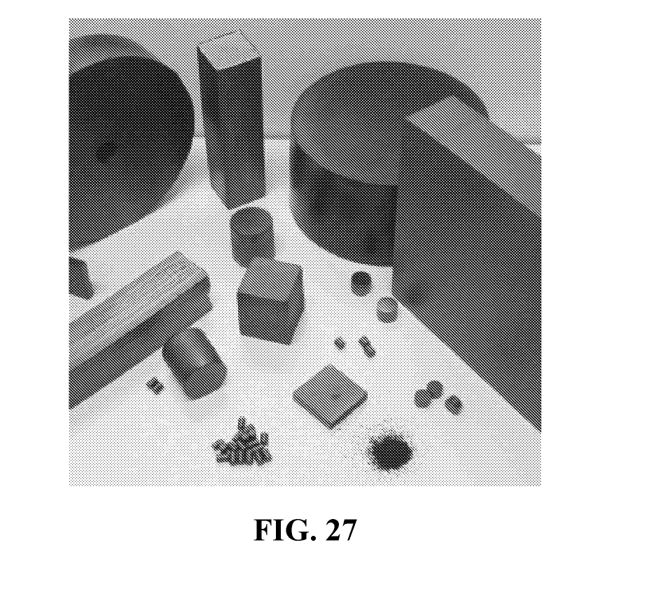

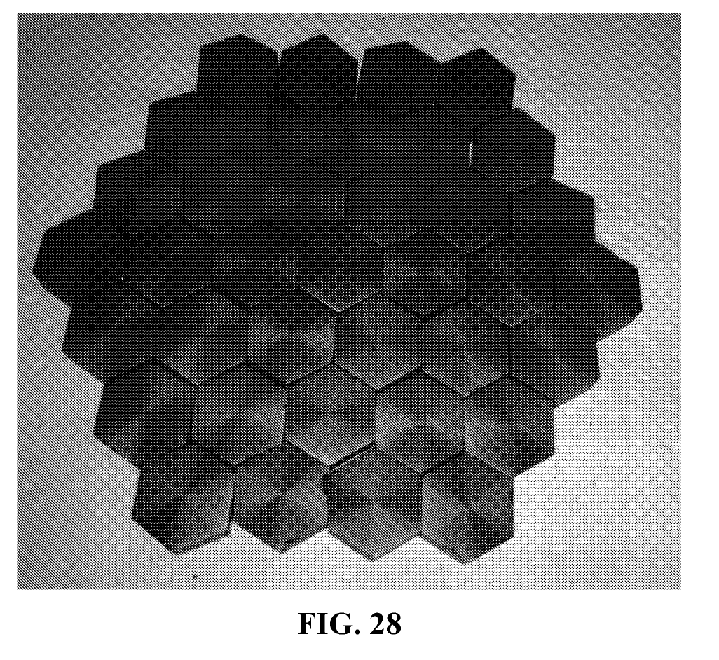

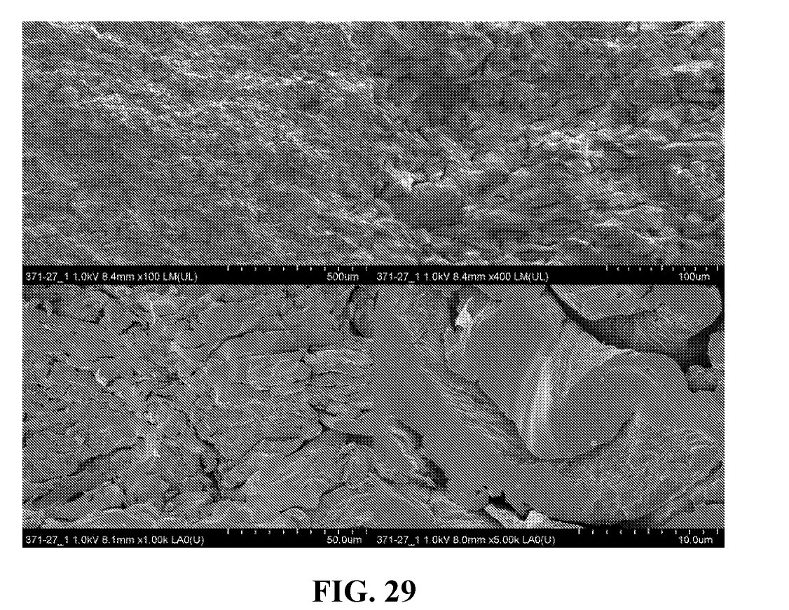

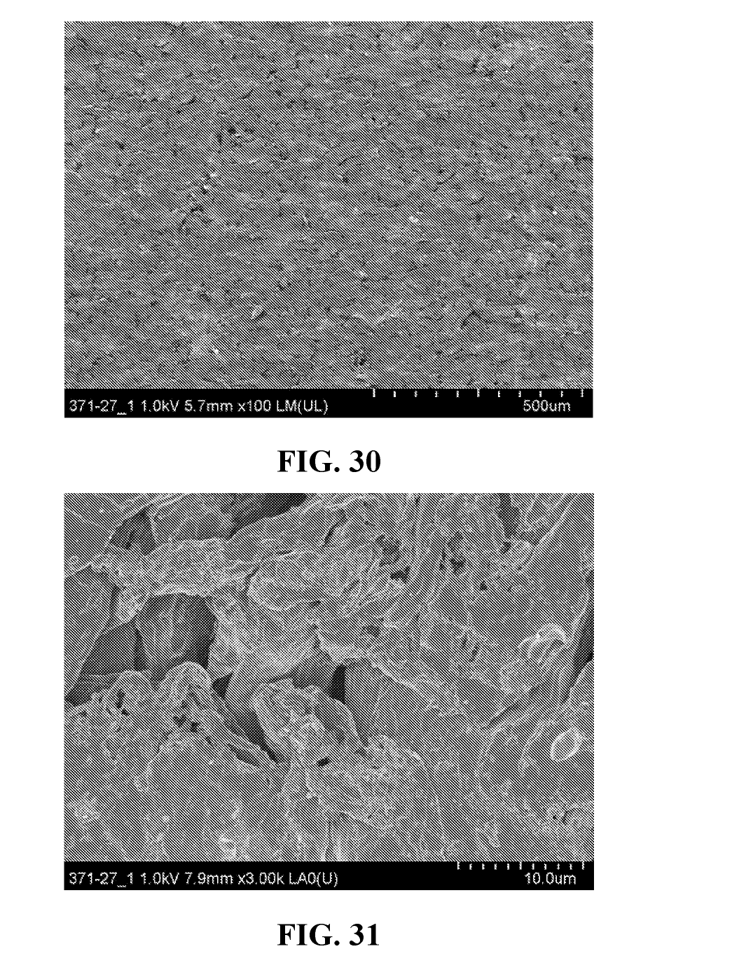

These microcrystalline cellulose tablets were pyrolyzed to 800° C. in flowing N₂, thus yielding fully carbonized tablets, following which oxidative activation was performed in flowing CO₂ at 900° C. for varied lengths of time to control degree of burn-off. Such tablets are depicted in FIGS. 25-26 and 29-31, and are of cylindrical form. Forms other than cylindrical are contemplated in the broad practice of the present disclosure. For reference, FIG. 27 is a photograph showing a variety of shapes and sizes of formed carbon pyrolyzate adsorbent pieces prepared via preforming and controlled pyrolysis, and FIG. 28 is a photograph of one embodiment of carbon pyrolyzate adsorbent articles having a space-filling shape, which can be arranged so that adjacent carbon pyrolyzate adsorbent articles are in contact with one another, so that the corresponding array of carbon pyrolyzate adsorbent articles can be employed for maximizing adsorbent density within the enclosed volume of an adsorbent vessel adapted for holding gas for which the carbon pyrolyzate adsorbent has sorptive affinity.

The densities of the pyrolyzed tablets were ˜0.90-1.15 g/cc. The pyrolyzed tablets were roughly 0.86 cm in diameter and 0.54 cm in height. Yields on the pyrolyzed tablets were ˜19%-24% wt., and yields on the CO₂ activated tablets were ˜8-19% wt. The calculated burn-off ranged from ˜5%-60% wt.

Carbonized and activated tablets were thereafter subjected to full N₂ and CO₂ isothermal porosimetry analysis. Porosimetry results are set out in Table 4 below.

TABLE 4
Porosimetry Results on Pyrolyzed and Activated Microcrystalline Cellulose Derived Carbon
Tablets

| | Compression | Compression | Pyrolysis | Activation | Activation | CO₂ Flow |
|---|---|---|---|---|---|---|
| | Time | Load | Temperature | Temperature | Time | Rate |
| Sample # | (min) | (Mg/cm²) | (deg C.) | (deg C.) | (min) | (L/min) |
| N0190-93-ACM03 | 1 | 1000 | 800 | 800 | 0 | 0 |
| N0190-93-ACM10 | 1 | 1000 | 800 | 800 | 1140 | 0.5 |
| N0190-93-ACM15 | 30 | 1000 | 800 | 800 | 0 | 0 |
| N0190-93-ACM17 | 30 | 1000 | 800 | 800 | 1140 | 0.5 |
| N0190-93-ACM14 | 1 | 1000 | 800 | 900 | 720 | 0.5 |
| N0190-93-ACM18 | 30 | 1000 | 800 | 900 | 60 | 0.5 |
| N0190-93-ACM20 | 1 | 1000 | 800 | 900 | 210 | 0.5 |
| N0190-93-ACM21 | 1 | 1000 | 800 | 900 | 360 | 0.5 |
| N0190-93-ACM23 | 1 | 1000 | 800 | 900 | 600 | 0.5 |
| N0190-93-ACM26 | 1 | 1000 | 800 | 900 | 60 | 0.5 |
| N0190-90-MCS01 | 0.25 | 1500 | 600 | 600 | 0 | 0 |
| N0190-91-MCS10 | 0.25 | 1900 | 600 | 900 | 60 | 0.5 |

| | | | | Micropore | N₂ BET | CO₂ Ads. | Calc. CH₄ |
|---|---|---|---|---|---|---|---|
| | Yield | Burn-Off | Density | Volume | Surface Area | Capacity | Capacity |
| Sample # | (% wt) | (% wt) | (g/cc) | (cm³/g) | (m²/g) | (cm³/g) | (V/V) |
| N0190-93-ACM03 | 20.66 | 0.00 | 1.07 | 0.19 | 468 | 74 | 53.1 |
| N0190-93-ACM10 | 17.96 | 13.10 | 1.04 | 0.31 | 790 | 103 | 86.0 |
| N0190-93-ACM15 | 20.04 | 0.00 | 0.91 | 0.19 | 474 | 75 | 46.0 |
| N0190-93-ACM17 | 17.69 | 14.42 | 0.94 | 0.33 | 825 | 105 | 81.3 |
| N0190-93-ACM14 | 8.45 | 58.82 | 0.57 | 0.87 | 2146 | 120 | 125.9 |
| N0190-93-ACM18 | 19.72 | 5.81 | 1.10 | 0.24 | 606 | 86 | 70.1 |
| N0190-93-ACM20 | 16.88 | 18.96 | 0.95 | 0.36 | 903 | 106 | 89.5 |
| N0190-93-ACM21 | 13.99 | 33.04 | 0.85 | 0.52 | 1286 | 111 | 114.1 |
| N0190-93-ACM23 | 9.48 | 54.25 | 0.63 | 0.80 | 1990 | 120 | 129.8 |
| N0190-93-ACM26 | 19.27 | 5.78 | 1.07 | 0.24 | 610 | 88 | 68.6 |
| N0190-90-MCS01 | 18.86 | 0.00 | 0.90 | 0.24 | 606 | 81 | 57.7 |
| N0190-91-MCS10 | 15.76 | 27.39 | 0.77 | 0.50 | 1247 | 108 | 99.9 |

A graph of burn-off level (% wt.) as a function of processing time at 900° C. in CO₂ is shown in FIG. 15 for the microcrystalline cellulose carbon tablets.

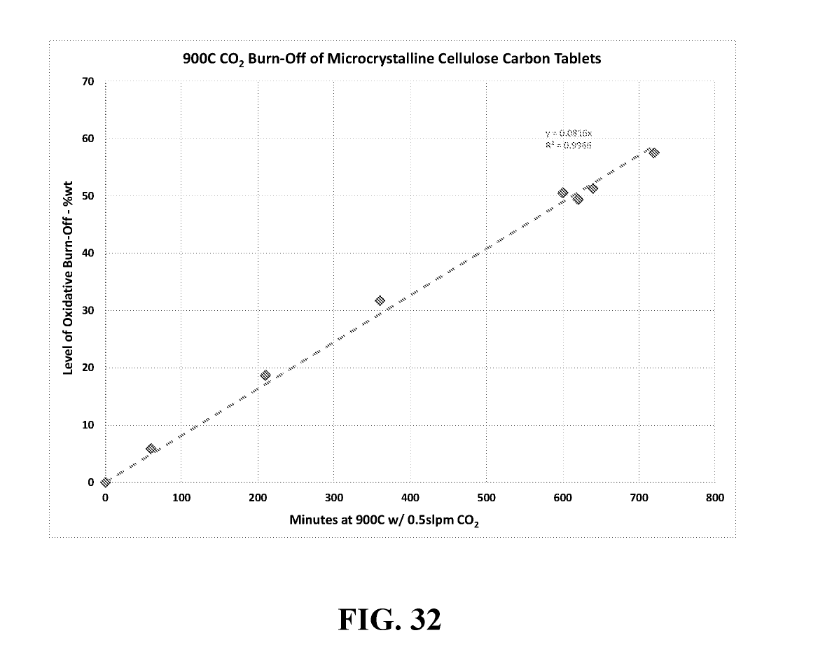

The rate of burn-off at 900° C. thus appeared as a linear function, with the linearity of the FIG. 32 graph evidencing the consistency and reproducibility of the empirical efforts. The data suggest that 60-minute activation under these conditions in CO₂ would yield only about 5% wt burn-off.

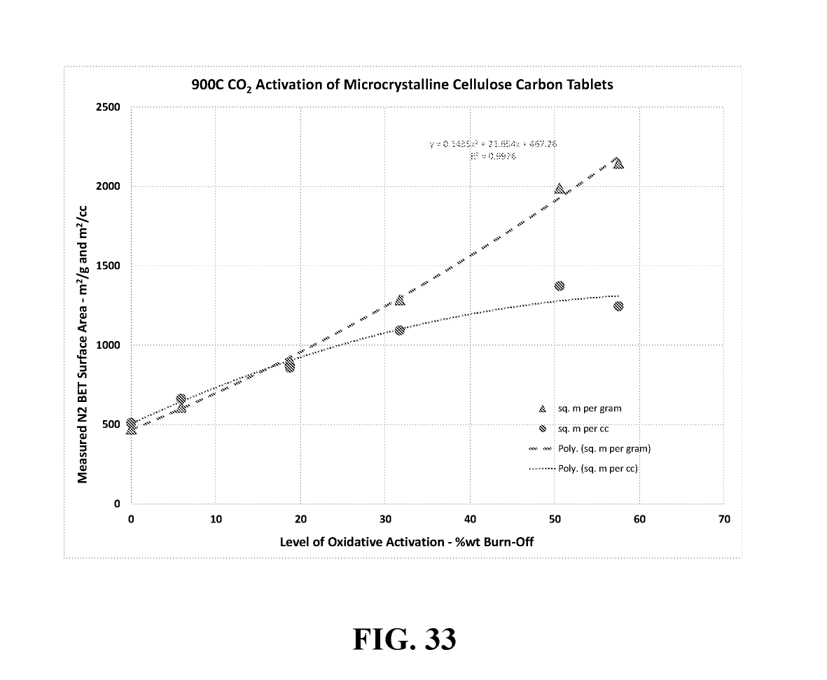

Surface area (both gravimetric and volumetric) of the microcrystalline cellulose carbon tablets is plotted as a function of the level of burn-off in FIG. 33. From this graph, it is seen that burn-off of approximately 50% wt. yielded a surface area of 1990 m²/g and that burn-off of approximately 57.5% wt. yielded a surface area of approximately 2147m²/g, with the volumetric surface area falling off at these high burn-off levels and the benefit of higher activation level being minimal or perhaps negative when yield is considered.

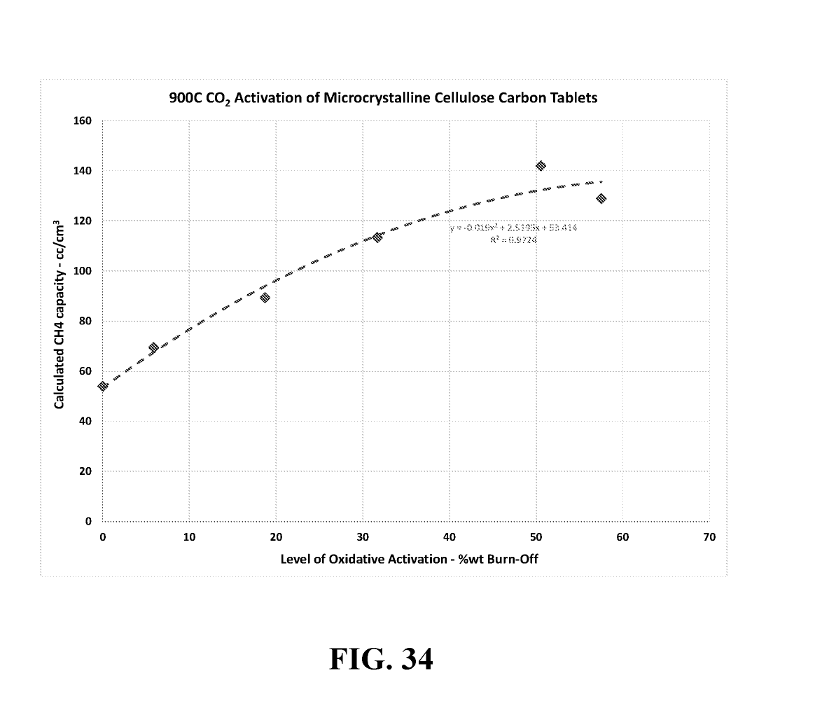

Using a previously established very strong correlation between measured density and gravimetric N₂ BET surface area with the volumetric adsorption capacity for methane for ultramicroporous adsorbent carbons, estimated CH₄ volumetric capacity was calculated for each sample. CH₄ volumetric capacity estimate versus level of burn-off is plotted in FIG. 34 for the microcrystalline cellulose carbon tablets activated using CO₂ at 900° C. From this graph, it is seen that higher burn-off levels result in methane capacity approaching ˜140 V/V.

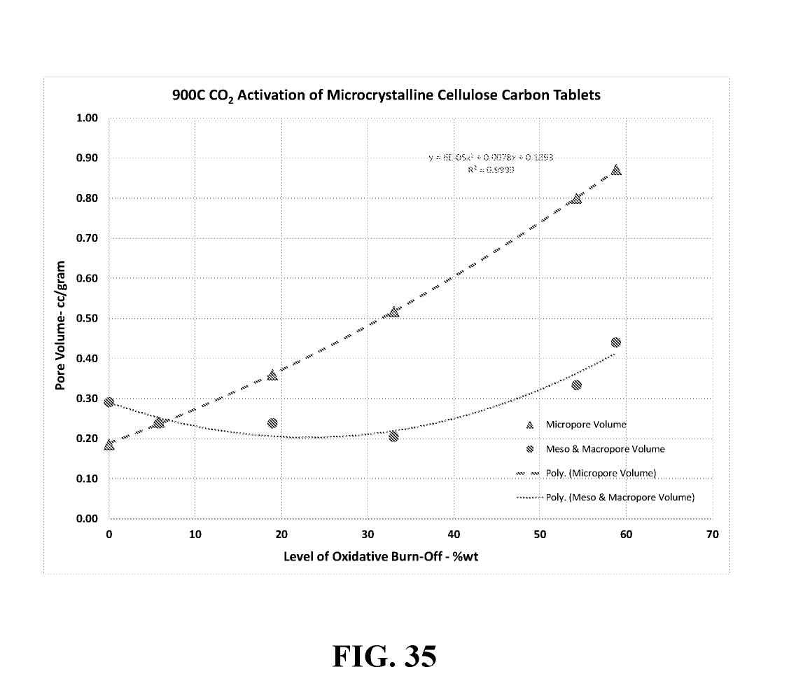

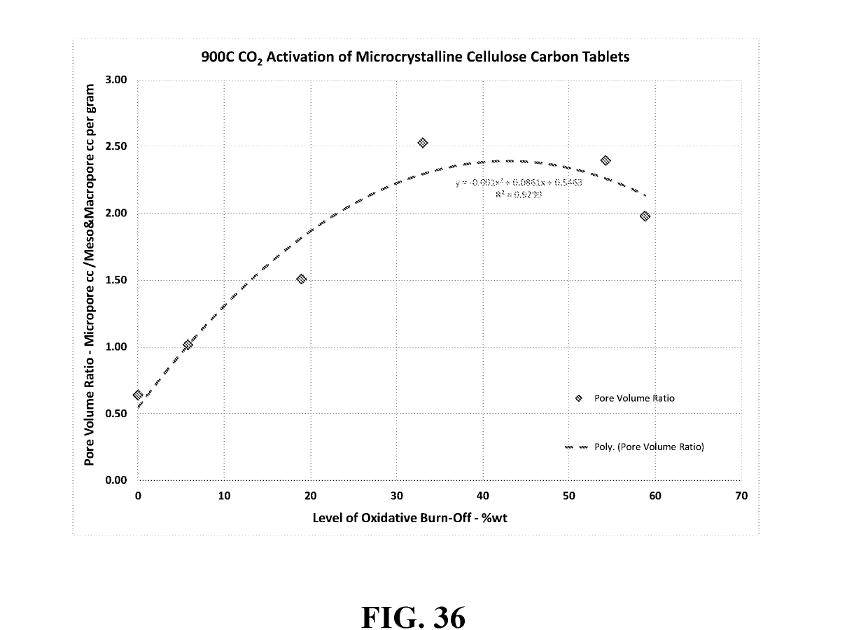

Measured micropore volume and calculated meso+macropore volume versus burn-off level is plotted in FIG. 35 for the microcrystalline cellulose carbon tablets activated using CO₂ at 900° C. This plot shows that at burn-off levels above 35% wt, the amount of meso- and macro-pore volume of the microcrystalline cellulose carbon tablets begins to increase. The ratio of millipore volume to meso+macropore volume for the microcrystalline cellulose carbon tablets activated using CO₂ at 900° C. is estimated in FIG. 36 as a function of burn-off level. These results suggest that optimized microcrystalline cellulose carbon exists at a burn-off level between 19% and 33% with respect to density and micropore volume for methane adsorption, at a density of 0.9 +/−0.05 g/cc and a yield of 14-17% wt. Higher degrees of oxidative activation appear to be opening up larger pores and decreasing carbon density with little corresponding benefit.

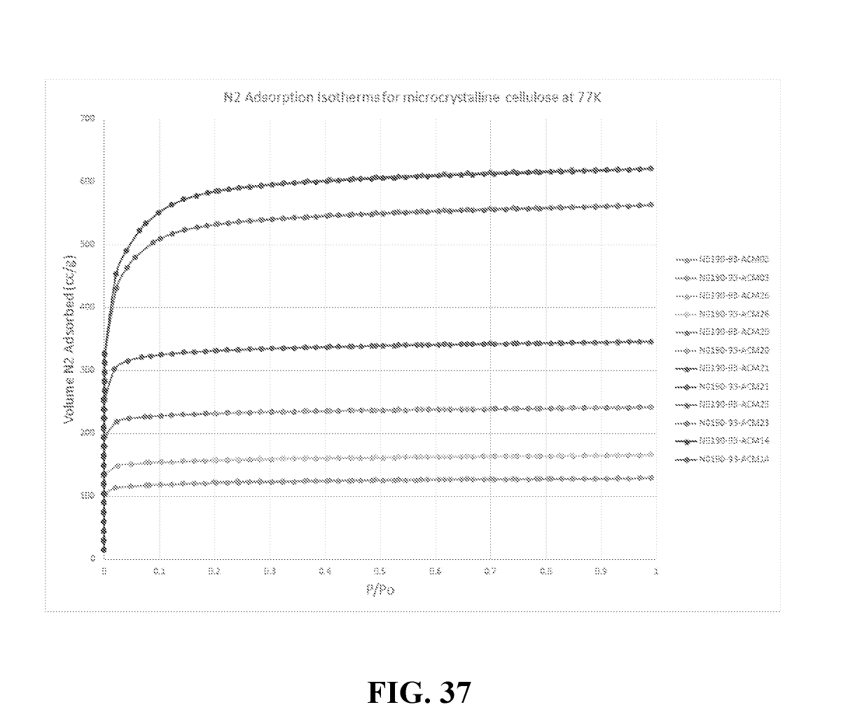

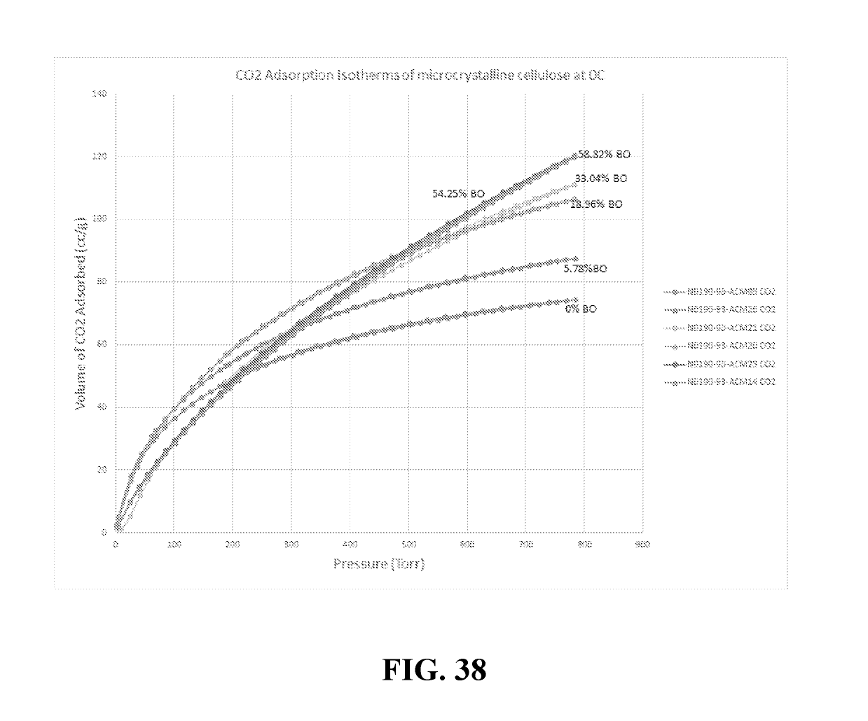

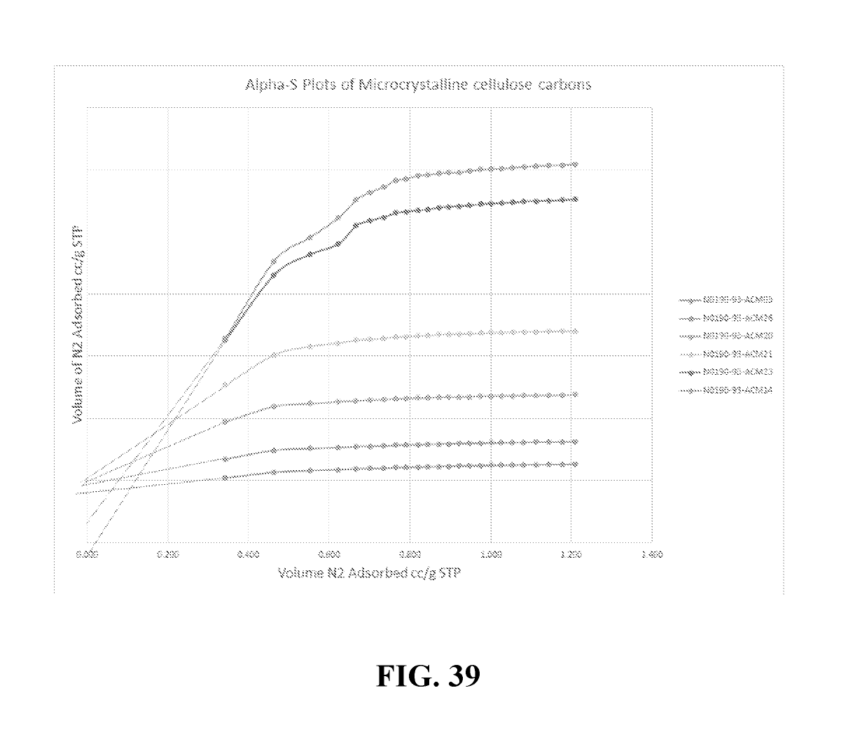

FIG. 37 shows the nitrogen adsorption isotherms for the microcrystalline cellulose samples at 77° Kelvin (volume of nitrogen adsorbed (cc nitrogen/gram), as a function of pressure). FIG. 38 shows the CO₂ adsorption isotherms for the microcrystalline cellulose samples at 0° C. (volume of CO₂ adsorbed (cc nitrogen/gram), as a function of pressure (torr)). FIG. 39 shows the alpha-S plots for the microcrystalline cellulose samples (volume of nitrogen adsorbed, in cc/g at standard temperature and pressure conditions, as a function of volume of nitrogen adsorbed, in cc/g at standard temperature and pressure conditions). From this series of porosimetry plots it can be seen that although surface area continues to increase with burn-off levels above 35% wt the shape of the isotherms indicates pore widening at these higher activation levels. For most of the gas molecules discussed herein for targeted adsorptive storage and desorptive delivery the wider pores would have no benefit and would sacrifice volumetric capacity.

Thus, the present disclosure contemplates a method of supplying packaged gas for use, such method comprising packaging a cellulosic carbon pyrolyzate in a gas supply package. The cellulosic carbon pyrolyzate may be of any suitable type as herein variously disclosed.

In another aspect, the disclosure relates to a gas purifier, comprising a housing defining an interior volume and adapted for flow of gas therethrough, and cellulosic carbon pyrolyzate adsorbent of the present disclosure in the interior volume of the housing, arranged for contact with the gas flowed through the housing to sorptively purify the gas. A further aspect the disclosure relates to a method of supplying a purified gas for manufacturing a product selected from the group consisting of semiconductor products, flat-panel dsplays, and solar panels, such method comprising the use of one or more gas purifiers of such character.

Another aspect of the disclosure relates to an air filtering and/or purifying device, comprising a housing holding a filtration material comprising cellulosic carbon pyrolyzate adsorbent of the present disclosure arranged for contact with an air flow directed through the housing for adsorptive removal of air impurities.

Another aspect the disclosure relates to a gas supply package, comprising a gas storage and dispensing vessel containing a cellulosic carbon pyrolyzate adsorbent of the present disclosure, has variously described herein, for reversibly retaining gas thereon in an adsorbed state, and desorbing gas for discharge from the vessel under dispensing conditions of the gas supply package.

In a further aspect, the disclosure relates to an adsorbent, comprising a pyrolyzate of cellulose precursor material and one or more non-cellulose precursor material. In such adsorbent, the one or more non-cellulose precursor material is selected from the group consisting of synthetic polymeric materials, petroleum-based materials, petroleum-derived materials, carbohydrates other than cellulose, and combinations, blends, and mixtures of the foregoing. The one or more non-cellulose precursor material may for example be selected from the group consisting of polyvinylidene chloride polymers and copolymers, and polyvinylidene fluoride polymers and copolymers. In various embodiments, the one or more non-cellulose precursor material may be selected from the group consisting of starches and maltodextrins.

In the adsorbent as variously described herein, the cellulose precursor material may comprise microcrystalline cellulose. The adsorbent may for example comprise a pyrolyzate of cellulose precursor material comprising two or more different cellulose materials.

In various embodiments, the adsorbent of the present disclosure may comprise a concentration of cellulose precursor material of at least 50% by weight, based on total weight of the cellulose precursor material and non-cellulose precursor material.

The adsorbent of the present disclosure may be activated in any suitable manner, e.g., by chemical and/or physical activation. For example, the pyrolyzate may be activated by burn-off in exposure to CO₂, air, or steam in mixture with an inert gas or as a pure gas stream at temperature in a range of from 600° C. to 1200° C.

In various embodiments, the adsorbent of the present disclosure may comprise: (i) a microcrystalline cellulose pyrolyzate; and (ii) a pyrolyzate of at least one of (a) starch and (b) maltodextrin. Thus, for example, the adsorbent may comprise a microcrystalline cellulose pyrolyzate and a pyrolyzate of starch, or alternatively, the adsorbent may comprise a microcrystalline cellulose pyrolyzate and a pyrolyzate of maltodextrin, or alternatively, the adsorbent may comprise a microcrystalline cellulose pyrolyzate, a starch pyrolyzate, and a pyrolyzate of maltodextrin.

The disclosure in a further aspect relates to a gas supply package, comprising a vessel holding an adsorbent of the present disclosure, as variously described herein, for adsorptive storage of gas thereon and for desorption of gas therefrom under dispensing conditions of the gas supply package.

Yet another aspect of the disclosure relates to a gas filter and/or purifier, comprising a housing through which gas is flowed for filtration and/or purification, the housing holding an adsorbent of the present disclosure, as variously described herein, for contact with the gas.

Still another aspect of the disclosure relates to a method of packaging gas, comprising adsorbing the gas on an adsorbent of the present disclosure, as variously described herein, wherein the adsorbent is packaged in a gas storage and dispensing vessel.

A further aspect the disclosure relates to a method of filtering and/or purifying gas, comprising contacting the gas with an adsorbent of the present disclosure, as variously described herein, having sorptive affinity for one or more components of such gas.

The disclosure, as variously set out herein in respect of features, aspects and embodiments thereof, may in particular implementations be constituted as comprising, consisting, or consisting essentially of, some or all of such features, aspects and embodiments, as well as elements and components thereof being aggregated to constitute various further implementations of the disclosure. The disclosure correspondingly contemplates such features, aspects and embodiments, or a selected one or ones thereof, in various permutations and combinations, as being within the scope of the present disclosure.

The adsorbent of the present disclosure may be formed, manufactured, and utilized as variously described herein in any of the embodiments thereof, and such adsorbent may be characterized by any of the adsorbent characteristics described herein, including selected one or ones thereof, as variously described.

Accordingly, while the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1.-75. (canceled)

76. A cellulosic carbon adsorbent comprising microporous pyrolyzate derived from microcrystalline cellulose material and having reversibly adsorbed thereon a gas for manufacture of a product selected from the group consisting of semiconductor products, fiat-panel displays, and solar panels.

77. The cellulosic carbon adsorbent of claim 76, wherein the gas comprises a gas selected from the group consisting of (i) hydrides, (ii) halides, (iii) organometallics, (iv) hydrogen, (v) carbon dioxide, (vi) carbon monoxide, (vii) methane, (viii) natural gas, (ix) ethane, (x) ethylene, (xi) propane, (xii) propylene, (xiii) butane, (xiv) butylene, and combinations of two or more of these gases.

78. The cellulosic carbon adsorbent of claim 77, wherein the gas comprises a semiconductor manufacturing gas selected from the group consisting of dopant gases for ion implantation, precursors for vapor deposition processes, etchants, cleaning reagents, gas mixtures of two or more of the foregoing, and gas mixtures including one or more of the foregoing gases in combination with one or more of co-flow gases, carrier gases, and diluents.

79. The cellulosic, carbon adsorbent of claim 76, wherein the gas comprises a semiconductor manufacturing dopant gas for ion implantation which is an isotopically enriched variant, isotopically enriched above a natural abundance level of at least one isotope of an element thereof, and wherein the isotopically enriched level above the natural abundance level is in a range of from 5% in 100% of the difference between natural abundance level and 100% isotopic concentration in the gas of the isotopically enriched element.

80. The cellulosic carbon adsorbent of claim 76, wherein the gas comprises an isotopically enriched gas selected from the group consisting of (i) boron-containing gas, (ii) silicon-containing gas, (iii) germanium-containing gas, or any of the forgoing in combination with one of more co-flow gases, carrier gases, and diluents.

81. The cellulosic carbon adsorbent of claim 78. wherein the semiconductor manufacturing gas comprises a gas mixture of two or more of the foregoing, or a gas mixture including one or more of the foregoing in combination with one or more of co-flow gases, carrier gases, and diluents, wherein concentration of each component gas of the gas mixture is in a range of from 2 to 98% by volume, wherein the volume percentages of all component gases of the gas mixture total to 100 volume percent.

82. The cellulosic carbon adsorbent of claim 76, comprising a pyrolyzate of one or more of wood pulp, sawdust, newsprint, coconut shells, olives stones, peach stones, apricot pits, viscose, viscose-rayon, cotton, cotton linters, argan nutshell, macadamia nutshell, cellulose acetate, bacterial cellulose, lignin, blackthorn stones, walnut shells, date stones, rice husks, coffee parchment, coffee dregs, bagasse, sorghum millets straws, bamboo woods, mango pits, almond shells, corncobs, cherry stones, and grape seeds.

83. The cellulosic carbon adsorbent of claim 76, wherein the carbon adsorbent is in a monolithic form.

84. The cellulosic carbon adsorbent of claim 76, wherein the carbon adsorbent is in a particulate form.

85. The cellulosic carbon adsorbent of claim 76, characterized by any one or more of the following characteristics: having less than 0.5% total ash content, as determined by the procedure of ASTM D2866, having a piece density of from 0.55 g/cc to 1.30 g/cc; having a hulk density a from 0.5 g/cc to 1.3 g/cc; the adsorbent being binderless; having N₂ BET surface area in a range of from 750 to 3000 m2/gram; having from 50% to 90%, or higher, of its pore volume in micropores having size in a range of from 0.3 nm to 2.0 nm; having methane adsorption capacity, at 21° C. and 35 bar pressure, in a range of from 140 V/V to 220 V/V; and having methane adsorption working/delta capacity between 35 bar and 1 bar, in a range of from 75 to 125 V/V

86. The cellulosic carbon adsorbent of claim 76, comprising a pyrolyzate of cellulose precursor material and one or more non-cellulose precursor material, wherein the one or more non-cellulose precursor material is selected from the group consisting of synthetic polymeric materials, petroleum-based materials, petroleum-derived materials, carbohydrates other than cellulose, and combinations, blends, and mixtures of the foregoing.

87. The cellulosic carbon adsorbent of claim 86. wherein the one or more non-cellulose precursor material is selected from the group consisting of polyvinylidene chloride polymers and copolymers, and polyvinylidene fluoride polymers and copolymers.

88. The cellulosic carbon adsorbent of claim 86, wherein the one or more non-cellulose precursor material is selected from the group consisting of starches and maltodextrins.

89. The adsorbent of claim 86, comprising:
(i) a microcrystalline cellulose pyrolyzate; and
(ii) a pyrolyzate of at least one of (a) starch and (b) maltodextrin.

90. The cellulosic carbon adsorbent of claim 76, comprising a pyrolyzate of cellulose precursor material comprising two or more different cellulose materials.

91. The cellulosic carbon adsorbent of claim 86, wherein the concentration of cellulose precursor material is at least 50% by weight, based on total weight of the cellulose precursor material and non cellulose precursor material.

92. The adsorbent of claim 86, wherein the cellulose precursor material is present at concentration of from 55 to 98% by weight, based on total weight of the cellulose precursor material and non-cellulose precursor material.

93. The cellulosic carbon adsorbent of claim 76, comprising a microporous pyrolyzate activated by chemical and/or physical activation.

94. The cellulosic carbon adsorbent of claim 93, wherein the microporous pyrolyzate has been activated by burn-off in exposure to CO₂, air, or steam in mixture with an inert gas or as a pure gas stream at temperature in a range of from 600° C. to 1200° C.

95. A gas supply package, comprising a gas storage and dispensing vessel containing a cellulosic carbon adsorbent according to claim. 76 for reversibly retaining gas thereon in an adsorbed state, and desorbing gas for discharge from the vessel under dispensing conditions of the gas supply package.
